(19) United States
(12) Patent Application Publication
(10) Pub. No.: US 2022/0309779 A1
(43) Pub. Date: Sep. 29, 2022

(54) NEURAL NETWORK TRAINING AND APPLICATION METHOD, DEVICE AND STORAGE MEDIUM

(71) Applicant: CANON KABUSHIKI KAISHA, Tokyo (JP)

(72) Inventors: Deyu Wang, Beijing (CN); Dongchao Wen, Beijing (CN); Wei Tao, Beijing (CN); Lingxiao Yin, Beijing (CN)

(21) Appl. No.: 17/703,858

(22) Filed: Mar. 24, 2022

(30) Foreign Application Priority Data
Mar. 26, 2021 (CN) 202110325842.4

(51) Int. Cl. G06V 10/96; G06V 10/82; G06V 10/766; G06N 3/08

(52) U.S. Cl. CPC G06V 10/96; G06V 10/82; G06V 10/766; G06N 3/08

(57) ABSTRACT

The invention provides a neural network training and application method, device and storage medium. The training method comprises: an obtaining step of obtaining a processing result and a loss function value of the processing result for at least one task after a sample image is processed in a neural network; wherein the neural network comprises at least one network structure; a determination step of determining importance of the processing result thereof based on the obtained loss function value; an adjustment step of adjusting a weight of the loss function for obtaining the loss function value based on the determined importance; and an update step of updating the neural network according to the loss function after the weight is adjusted.

### TECHNICAL FIELD

The present disclosure relates to image processing, and more particularly, to a neural network training and application method, device and storage medium.

### BACKGROUND

In the training process of a neural network model, a sample which is difficult to be recognized by the model is set as a difficult sample, and conversely, a sample which is easy to be recognized by the model is set as an easy sample. In the samples trained by the neural network, there is usually a problem of unbalanced sample proportion, for example, unbalanced proportion of difficult and easy samples, which will affect the recognition performance of the network for the samples with lower proportion. Thus, giving different attention to different samples to allow the network to focus more on samples with a lower proportion in the training can significantly improve the problem.

In order to solve the above problem, the non-patent document “Prime Sample Attention in Object Detection” (Yuhang Cao, Kai Chen, Chen Change Loy, Dahua Lin; CVPR 2020) proposes a method for making the neural network focus more on the prime samples for learning. In the method, prime samples are selected according to the sorting of the sample hierarchy, which comprises three steps: 1) local grouping: in positive samples, the samples are grouped by matching with real labels. In negative samples, the samples are grouped by a non-maximum suppression algorithm. 2) In-group sorting: for positive samples, descending sorting is performed according to an Intersection-over-union score of the samples and the target regions in the real labels. And for negative samples, descending sorting is performed according to a classification score of the samples. 3) Layering sorting: all samples with the same in-group rank are classified into one layer, and then samples in each layer are further sorted. Finally, a target loss function is re-weighted according to the sorting rank.

As described above, in the method based on sample attention, attention of samples is usually calculated in the unit of each sample. However, these methods ignore the difference in importance of different tasks in the samples.

### SUMMARY

In view of the above description in the background art, the present disclosure provides a method for evaluating importance in unit of task in samples, rather than in unit of sample, which enables a network to focus more on training of important tasks in a sample, thereby further improving network accuracy.

According to an aspect of the present disclosure, there is provided a training method of a neural network, the training method comprises: obtaining a processing result and a loss function value of the processing result for at least one task after a sample image is processed in the neural network, wherein the neural network comprises at least one network structure; determining importance of the processing result thereof based on the obtained loss function value; adjusting a weight of the loss function for obtaining the loss function value based on the determined importance; and updating the neural network according to the loss function after the weight is adjusted.

According to another aspect of the present disclosure, there is provided a training method of a neural network, which is characterized in that the neural network comprises at least a first portion and a second portion receiving an output of the first portion, the first portion comprising at least one sub-network structure, the training method comprising: obtaining a first processing result and a first loss function value of the first processing result for at least one task after a sample image is processed in the first portion of the neural network; and updating the first portion of the neural network according to the first loss function; obtaining a second loss function of a second processing result for the at least one task after the sample image is processed in the second portion of the neural network; determining a first importance of the first processing result based on the first loss function value; adjusting, based on the first importance, a weight of the second loss function for obtaining a value of the second loss function of the second processing result; and updating the second portion of the neural network according to the second loss function after the weight is adjusted.

According to yet another aspect of the present disclosure, there is provided a training device of a neural network, the training device comprises: an obtaining unit configured to obtain a processing result and a loss function value of the processing result for at least one task after a sample image is processed in the neural network, wherein the neural network comprises at least one network structure; a determination unit configured to determine importance of the processing result thereof based on the obtained loss function value; an adjusting unit configured to adjust a weight of the loss function for obtaining the loss function value based on the determined importance; and an updating unit configured to update the neural network according to the loss function after the weight is adjusted.

According to yet another aspect of the present disclosure, there is provided a training device of a neural network, which comprises at least a first portion and a second portion receiving an output of the first portion, the first portion comprising at least one sub-network structure, the training device comprising: a first obtaining unit configured to acquire a first processing result and a first loss function value of the first processing result for at least one task after a sample image is processed in the first portion of the neural network; and a first updating unit configured to update the first portion of the neural network according to the first loss function; a second obtaining unit configured to obtain a second loss function of a second processing result for the at least one task after the sample image is processed in the second portion of the neural network; a determination unit configured to determine a first importance of the first processing result based on the value of the first loss function; an adjusting unit configured to adjust, based on the first importance, a weight of the second loss function for obtaining a value of the second loss function of the second processing result; and a second updating unit configured to update the second portion of the neural network according to the second loss function after the weight is adjusted.

Further features of the present disclosure will become clear from the descriptions of the illustrative embodiments with reference to the following drawings.

### BRIEF DESCRIPTION OF THE DRAWINGS

The accompanying drawings, which are incorporated in and constitute a part of the description, illustrate exemplary embodiments of the present disclosure and, and together with the description of the exemplary embodiments, serve to explain the principles of the present disclosure.

FIG. 1 illustrates a block diagram of a hardware configuration according to one or more aspects of the present disclosure.

FIG. 2 illustrates a structure diagram of a training device of a neural network according to one or more aspects of the present disclosure.

FIGS. 3A to 3B illustrate a flow diagram of a training method of a neural network according to one or more aspects of the present disclosure.

FIGS. 4A to 4C illustrate a neural network model architecture.

FIGS. 5A to 5D illustrate flow diagrams of the training method of the neural network according to one or more aspects of the present disclosure.

FIGS. 6A to 6C illustrate flow diagrams of the training method of the neural network according to one or more aspects of the present disclosure.

FIGS. 7A-7F illustrate schematic diagrams of the training method of the neural network according to one or more aspects of the present disclosure.

FIG. 8A illustrates a structure diagram of a training device of a neural network according to one or more aspects of the present disclosure.

FIG. 8B illustrates a flow diagram of a training method of a neural network according to one or more aspects of the present disclosure.

FIG. 8C illustrates a schematic diagram of the training method of the neural network according to one or more aspects of the present disclosure.

FIG. 9 illustrates a schematic diagram of applying a training method of a neural network according to one or more aspects of the present disclosure.

FIG. 10 illustrates a schematic diagram of applying a training method of a neural network according to one or more aspects of the present disclosure.

FIG. 11 illustrates a schematic diagram of applying a training method of a neural network according to one or more aspects of the present disclosure.

FIG. 12 illustrates a schematic diagram of a training method of a neural network according to one or more aspects of the present disclosure.

FIG. 13 illustrates a schematic diagram of a training method of a neural network according to one or more aspects of the present disclosure.

FIG. 14 illustrates a schematic diagram of the training method of the neural network according to one or more aspects of the present disclosure.

FIG. 15 illustrates a schematic diagram of an application system according to one or more aspects of the present disclosure.

### DETAILED DESCRIPTION

Exemplary embodiments of the present disclosure will be described hereinafter with reference to the accompanying drawings. For the sake of clarity and conciseness, not all features of the embodiments have been described in the description. It should be appreciated, however, that in the implementation of the embodiments, numerous implementation-specific decisions must be made to achieve the developers' specific goals, such as meeting the device-related and business-related constraints, which may vary from one implementation to another. Moreover, it will be appreciated that such a development effort might be complex and time-consuming, but would nevertheless be a routine undertaking for those of ordinary skill in the art having the benefit of the present disclosure.

It is also noted herein that in order to avoid obscuring the present disclosure with unnecessary detail, only process steps and/or system structures closely related to at least the solution according to the present disclosure are shown in the accompanying drawings, while other details not closely related to the present disclosure are omitted.

(Hardware Configuration)

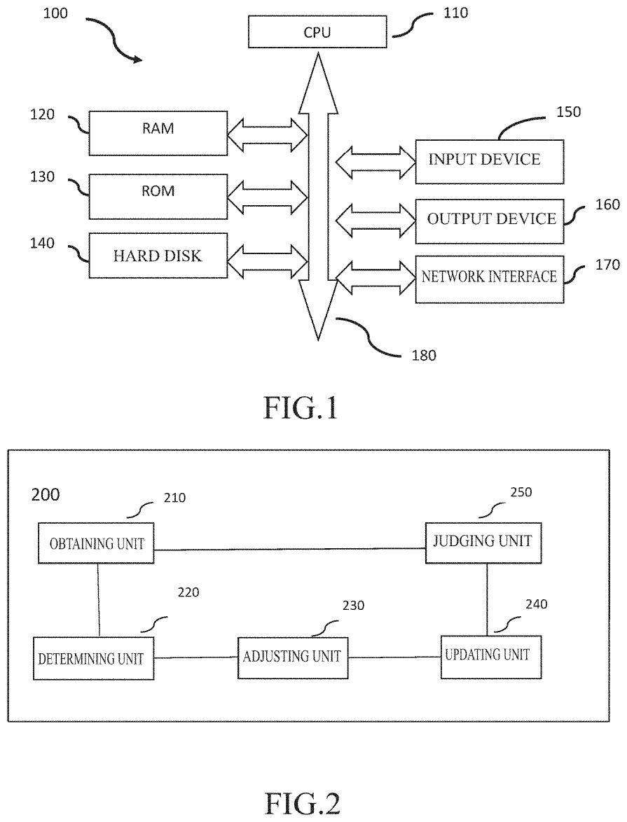

A hardware configuration that can implement the techniques described hereinafter will be described first with reference to FIG. 1.

A hardware configuration 100 includes, for example, a central processing unit (CPU) 110, a random access memory (RAM) 120, a read only memory (ROM) 130, a hard disk 140, an input device 150, an output device 160, a network interface 170, and a system bus 180. In one implementation, the hardware configuration 100 may be implemented by a computer, such as a tablet computer, a laptop computer, a desktop computer, or other suitable electronic device.

In one implementation, a device for training a neural network in accordance with the present disclosure is constructed from hardware or firmware and used as a module or component of hardware configuration 100. In another implementation, a method of training a neural network in accordance with the present disclosure is constructed from software stored in the ROM 130 or the hard disk 140 and executed by the CPU 110. In another implementation, the method of training a neural network in accordance with the present disclosure is constructed from software stored in the ROM 130 or the hard disk 140 and executed by the CPU 110.

The CPU 110 is any suitable programmable control device, such as a processor, and may perform various functions to be described hereinafter by executing various application programs stored in the ROM 130 or the hard disk 140, such as a memory. The RAM 120 is used to temporarily store programs or data loaded from the ROM 130 or the hard disk 140, and is also used as a space in which the CPU 110 performs various processes and other available functions. The hard disk 140 stores various information such as an operating system (OS), various applications, control programs, sample images, trained neural networks, predefined data (e.g., threshold values (THs)), and the like.

In one implementation, the input device 150 is used to allow a user to interact with the hardware configuration 100. In one example, the user may input a sample image and a label of the sample image (e.g., region information of the object, category information of the object, etc.) through the input device 150. In another example, a user may trigger corresponding processing of the present disclosure through the input device 150. In addition, the input device 150 may take a variety of forms, such as a button, a keyboard, or a touch screen.

In one implementation, the output device 160 is used to store the final trained neural network, for example, in the hard disk 140 or to output the finally generated neural network to subsequent image processing such as object detection, object classification, image segmentation, and the like.

The network interface 170 provides an interface for connecting the hardware configuration 100 to a network. For example, the hardware configuration 100 may be in data communication, via the network interface 170, with other electronic devices connected via a network. Optionally, the hardware configuration 100 may be provided with a wireless interface for wireless data communication. The system bus 180 may provide a data transmission path for mutually transmitting data among the CPU 110, the RAM 120, the ROM 130, the hard disk 140, the input device 150, the output device 160, the network interface 170, and the like. Although referred to as a bus, the system bus 180 is not limited to any particular data transfer technique.

The hardware configuration 100 described above is merely illustrative and is in no way intended to limit the present disclosure, its applications, or uses. Also, only one hardware configuration is shown in FIG. 1 for simplicity. However, a plurality of hardware configurations may be used as necessary, and the plurality of hardware configurations may be connected through a network. In this case, the plurality of hardware structures may be implemented by, for example, a computer (e.g., a cloud server), and may also be implemented by an embedded device, such as a camera, a camcorder, a personal digital assistant (PDA), or other suitable electronic devices.

Next, various aspects of the present disclosure will be described.

### First Exemplary Embodiment

Hereinafter, a training method of a neural network according to a first exemplary embodiment of the present disclosure will be described with reference to FIGS. 2 to 7B, and the training method is specifically explained as follows.

FIG. 2 is a configuration block diagram schematically illustrating a neural network training device 200 according to an embodiment of the present disclosure. Wherein some or all of the modules shown in FIG. 2 may be implemented by dedicated hardware. As shown in FIG. 2, the training device 200 includes an obtaining unit 210, a determination unit 220, an adjusting unit 230, an updating unit 240, and a judgment unit 250.

First, for example, the input device 150 shown in FIG. 1 receives a neural network, a sample image, and a label of the sample image, which are input by a user. Wherein the label of the input sample image contains real information of the object (e.g., region information of the object, category information of the object, etc.). The input device 150 then transmits the received neural network and sample image to the device 200 via the system bus 180.

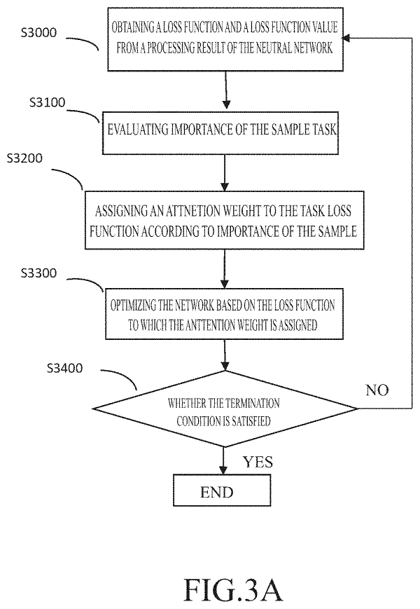

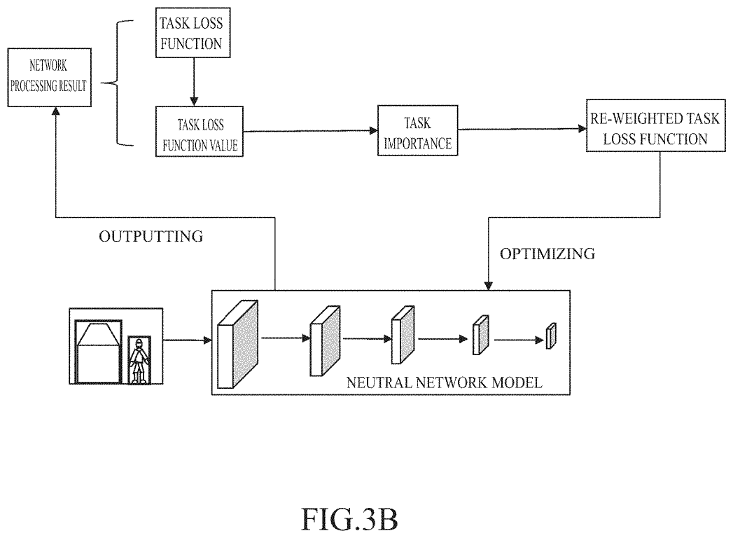

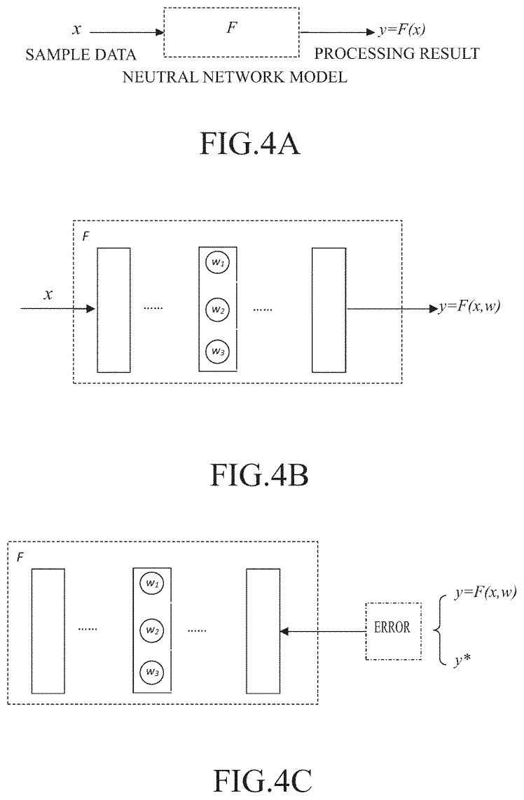

Then, as shown in FIG. 3, in step 3000, the obtaining unit 210 first obtains a loss function and a loss function value from the processing result of the neural network. FIG. 4A illustrates a simple neural network model architecture (a specific network architecture is not shown). After sample data x (image) to be trained is input into a neural network F, the x is operated layer by layer from top to bottom in the network model F, and finally an output result y meeting certain distribution requirements is output from the model F.

In step S3100, the determination unit 220 evaluates the importance of a sample task. In this step, a loss function value for each task in the sample is obtained from the neural network processing result, and then the importance of the task is evaluated based on the loss function value, wherein the importance evaluation may include both inter-task importance evaluation and intra-task importance evaluation, or may include only one aspect. The inter-task importance evaluation refers to importance evaluation of different tasks within same sample, while the intra-task importance evaluation refers to importance evaluation of the same task across different samples.

In step S3200, an attention weight is assigned to the task loss function by the adjusting unit 230 based on the importance of the sample task obtained by the determination unit 220 in step S3100. In this step, the inputs are the task loss function and its importance obtained in the previous step. And then an attention value corresponding to each task is calculated according to the importance, and the attention value is assigned as a weight to the loss function corresponding to each task.

In step S3300, the network is optimized by the updating unit 240. In this step, the difference between the network processing result and the true value is calculated using the loss function re-weighted by the adjusting unit 230 in step S3200, and network back propagation derivation is performed according to the difference. The parameters of the network are updated according to the gradient values obtained by the back propagation derivation. Because different loss functions have different weights, the influence of each loss function is different, and the influence is larger as the weight of the loss function is higher.

In step S3400, the judgment unit 250 determines whether the network output satisfies the termination condition. In this step, for example, the termination condition may be whether the number of iterations of the training reaches a predetermined value, whether a loss value of the training is lower than a predetermined threshold value, or the like. If the conditions are not met, the steps S3100-S3400 are repeated again according to the network processing result of the current state to train the network. If the conditions are met, the training process of the neural network is ended, and a network model is output.

As described above, after the above steps S3000 to S3400, the attention of the network can be adaptively adjusted in unit of task for the samples, rather than in unit of sample itself, which makes the network pay more attention to the training of important tasks, thereby further improving the network performance.

Taking the convolutional neural network model shown in FIGS. 4B and 4C as an example, assuming that there exists a convolutional layer including three weights w1, w2, and w3 in the model, in the forward propagation process shown in FIG. 4B, after a convolution operation is performed on the input feature map of the convolutional layer and the weights w1, w2, and w3 respectively, an output feature map of the convolutional layer is obtained and output to the next layer. An output result y of the network model is finally obtained through layer-by-layer operation. Compare the output result y with an output result y* expected by a user, and if the error between the two does not exceed a predetermined threshold, it indicates that the performance of the current network model is good; conversely, if the error between the two exceeds the predetermined threshold, the weights w1, w2 and w3 in the convolutional layer need to be updated in the back propagation process shown in FIG. 4C by using the error between the actual output result y and the expected output result y* to make the performance of the network model better. Here, the process of updating each weight in the network model is a training process of the network model, that is, an updating process of the neural network.

The training process of the neural network model is a cyclic and repeated process, each training comprises forward propagation and backward propagation, wherein the forward propagation is a process of operating the data x to be trained layer by layer from top to bottom in the neural network model, the forward propagation process described in the present disclosure can be a known forward propagation process, the process of the forward propagation can comprise the weight of any bit and the quantization process of a feature map, which is not limited in the present disclosure. If the difference between the actual output result and the expected output result of the neural network model does not exceed the predetermined threshold, it means that the weight in the neural network model is an optimal solution, the performance of the trained neural network model has reached the expected performance, and the training of the neural network model is completed. On the contrary, if the difference between the actual output result and the expected output result of the neural network model exceeds the predetermined threshold, the back propagation process needs to be continuously performed, that is, based on the difference between the actual output result and the expected output result, operation is performed layer by layer from bottom to top in the neural network model, and the weight in the model is updated, so that the performance of the network model after the weights is updated is closer to the expected performance.

The neural network model suitable for the present disclosure may be any known model, such as a convolutional neural network model, a recurrent neural network model, a graph neural network model, and the like, and the present disclosure does not limit the type of the network model.

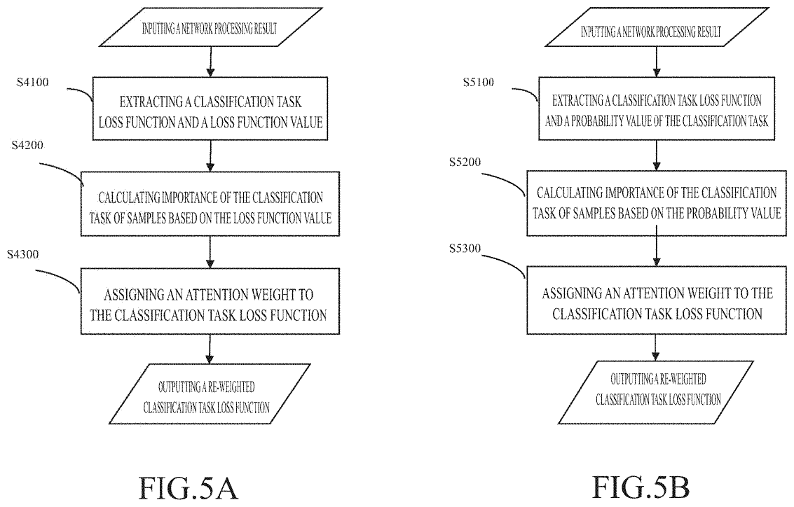

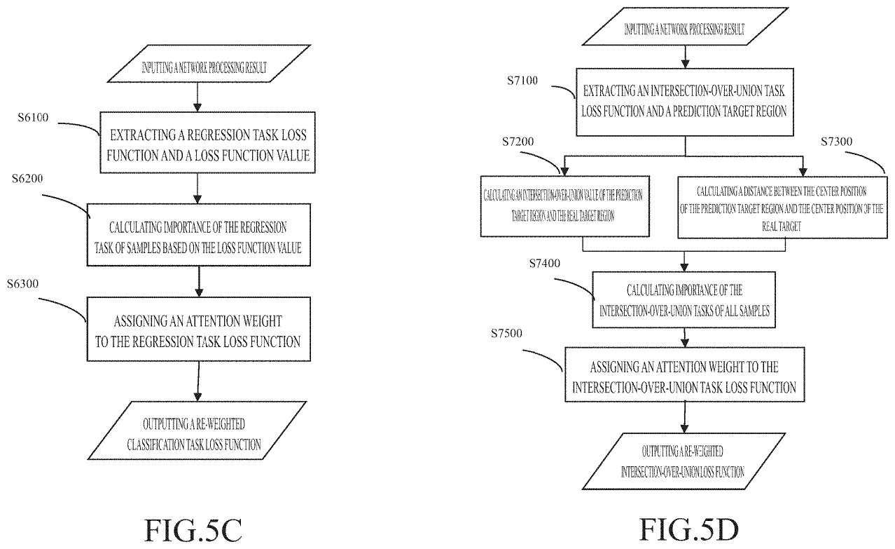

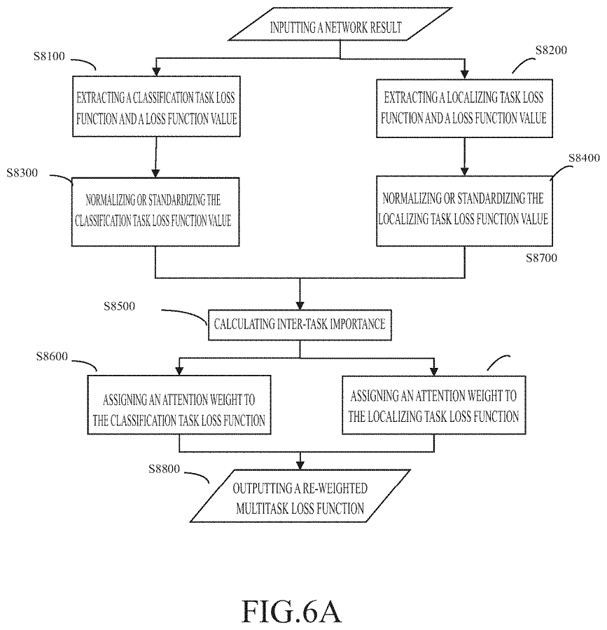

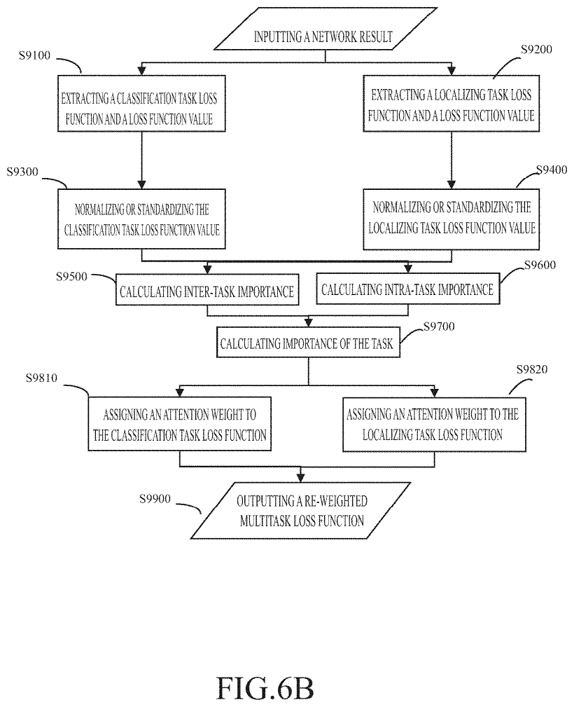

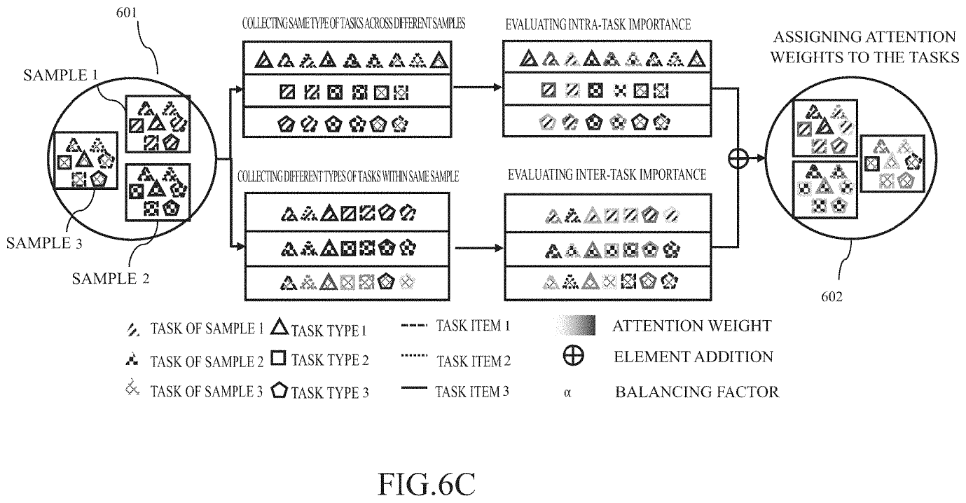

The neural network training process of steps S3100 to S3400 will be described in detail below with reference to FIGS. 5A to 6B.

First, intra-task importance evaluation, that is, evaluating the importance of the same task across different samples, is described with reference to FIGS. 5A to 5D.

The importance evaluation of a classification task is described first. The classification task generally uses a probabilistic loss function, and a loss value of the classification function being used to measure the importance of the classification task is described with reference to the flow diagram shown in FIG. 5A, and the greater the loss value, the higher the importance.

In step S4100, a loss function and a loss function value of the classification task are extracted. The network result may include loss functions, loss function values, and prediction results of a plurality of tasks, such as a classification task, a regression task, and an Intersection-over-union task, and in this step, a loss function and a loss function value of the classification task are extracted first.

In the step of obtaining a loss function of the sample classification task from the network processing result, a classification task loss function value of the samples may be calculated by a classification task loss function (e.g., a Cross Entropy loss function), and the function may be defined as the following Equation (1):

Lᵢ^{CE}=−I(yᵢ,m)log(p^{m}(xᵢ)) (1)

Where p^{m}(xᵢ) is a probability output of the network for the m-th class of the i-th sample in the multiple sample images, and yᵢ represents a real label value for the i-th sample.

Since the samples include positive and negative samples, the overall classification task loss function equation can be defined as the following Equation (2):

L_{cls}=Σᵢ₌₁ⁿLᵢ^{pos}(pᵢ,yᵢ)+Σⱼ₌₁^{k}Lⱼ^{neg}(pⱼ,yⱼ) (2)

Wherein n and k represent the number of positive samples and negative samples, respectively, p and y represent the classification probability value and the real label value of the samples, respectively, and Lᵢ^{pos} and Lⱼ^{neg} represent the loss functions of the positive samples and the negative samples, respectively.

I is an indicator function, which can be defined as the following Equation (3):

$$I = \{ \begin{matrix}1 & {y}_{i} = m \\ 0 & {y}_{i} \neq m\end{matrix} \qquad ( 3 )$$

Then, the reliabilities rᵢ^{pos} and rⱼ^{neg} of the loss functions of the positive samples and the negative samples are expressed by converting Lᵢ^{pos} and Lⱼ^{neg} into a form of likelihood estimation using Equation (3), wherein the reliabilities rᵢ^{pos} and rⱼ^{neg} of the classification loss functions of the positive samples and the negative samples are defined as the following Equations (4) and (5), respectively:

rᵢ^{pos}=e^{-L}^{ᵢ}^{^{pos}} (4)

rⱼ^{neg}=e^{-L}^{ᵢ}^{^{neg}} (5)

In step S4200, the importance of the classification task of all samples is calculated. In this step, based on the loss function value of the classification task obtained in step S4100, the reliabilities rᵢ^{pos} and rⱼ^{neg} of the classification task are first calculated by using an exponential function. Then, the reliabilities rᵢ^{pos} and rⱼ^{neg} are converted into classification task importances Iᵢ^{pos} and Iⱼ^{neg} and normalized. The normalization arms to ensure that a sum of the overall weights of the current loss function is consistent with a sum of the weights of the original loss function, thereby ensuring the stability of network training.

The reliabilities are converted into the importances Iᵢ^{pos} and Iⱼ^{neg} of the task through the following Equations (6) and (7),

Iᵢ^{pos}=1−rᵢ^{pos} (6)

Iₕ^{neg}=1−rᵢ^{pos} (6)

It should be noted that the importances Iᵢ^{pos} and Iⱼ^{neg} of the task can be directly represented by the reliabilities rᵢ^{pos} and rⱼ^{neg}, for example, when there is an error label in the data set of the training network. Therefore, the attention to the wrongly labeled samples in the network training process can be reduced, so that the influence of the medium and small error samples on the neural network training is increased, the training is more stable, and the accuracy of a network model is further improved.

Then, in step S4300, an attention weight is assigned to the loss function of the classification task, an intra-task normalization process is performed on the importances Iᵢ^{pos} and Iⱼ^{neg} through the following Equations (8) and (9) to obtain I′ᵢ^{pos} and I′ⱼ^{neg},

$$\begin{matrix}{I}_{i}^{{′}^{pos}} = \frac{{I}_{i}^{pos}}{\frac{1}{n} {\sum }_{i = 1}^{n} {I}_{i}^{pos}} & ( 8 ) \\ {I}_{j}^{{′}^{neg}} = \frac{{I}_{j}^{neg}}{\frac{1}{m} {\sum }_{j = 1}^{m} {I}_{j}^{neg}} & ( 9 )\end{matrix}$$

Finally, through the following Equation (10), the obtained importances I′ᵢ^{pos} and I′ⱼ^{neg} are used as the attention weights wᵢ^{pos} and wⱼ^{neg} of the classification task and are assigned to the corresponding classification task loss function to obtain a re-weighted classification loss function.

L_{cls}=Σᵢ₌₁ⁿwᵢ^{pos}Lᵢ^{pos}(pᵢ,yᵢ)+Σⱼ₌₁^{m}wⱼ^{neg}Lⱼ^{neg}(pⱼ,yⱼ) (10)

In another embodiment, for the importance evaluation of the classification task, a classification probability value can also be directly used as an evaluation index, which is specifically described with reference to FIG. 5B.

First, in step S5100, a loss function of the classification task and a probability value of the classification task are extracted from the network output result. Unlike step S4100, in this step, a loss function of the classification task and its prediction probability value are extracted from the network processing result. The classification loss function obtained from the network processing result includes a positive sample classification loss function and a negative sample classification loss function, which can be specifically represented by the following Equation (11):

L_{cls}=Σᵢ₌₁ⁿLᵢ^{pos}(pᵢ,yᵢ)+Σⱼ₌₁^{m}Lⱼ^{neg}(pⱼ,yⱼ) (11)

Wherein n and m represent the numbers of positive samples and negative samples, respectively, p and y represent the classification probability value and the real label value of the samples, respectively, and Lᵢ^{pos} and Lⱼ^{neg} represent the loss functions of the positive samples and the negative samples, respectively.

In step S5200, the importance of the classification task of all samples is calculated. In this step, the classification probability value of the samples obtained in step S5100 is directly used as the reliability of the task through Equations (12) and (13), and then the importances Iᵢ^{pos} and Iⱼ^{neg} are further calculated:

Iᵢ^{pos}=1−pᵢ^{pos} (12)

Iⱼ^{neg}=1−pⱼ^{neg} (13)

Similarly to the above described embodiment, when there is an error label in the data set of the training network, the importances Iᵢ^{pos} and Iᵢ^{neg} of the tasks can also be directly represented by the reliabilities pᵢ^{pos} and pⱼ^{neg}.

Then, similarly to step S4100, an intra-task normalization process is performed on the importance through the following Equations (14) and (15) to obtain I′ᵢ^{pos} and I′ⱼ^{neg}:

$${I}_{i}^{′ pos} = \frac{{I}_{i}^{p o s}}{\frac{1}{n} {\sum }_{i = 1}^{n} {I}_{i}^{p o s}} \qquad ( 14 )$$

$${I}_{j}^{′ neg} = \frac{{I}_{j}^{n e g}}{\frac{1}{m} {\sum }_{j = 1}^{m} {I}_{j}^{n e g}} \qquad ( 15 )$$

Then, in step S5300, similarly as in step S4300, an attention weight is assigned to a classification task loss function. Specifically, through the following Equation (16), the obtained importances I′ᵢ^{pos} and I′ⱼ^{neg} are used as attention weights wᵢ^{pos} and wⱼ^{neg} of the task and are assigned to the corresponding task loss function to obtain a re-weighted classification loss function:

L_{cls}=Σᵢ₌₁ⁿwᵢ^{pos}Lᵢ^{pos}(pᵢ,yᵢ)+Σⱼ₌₁^{m}wⱼ^{neg}Lⱼ^{neg}(pⱼ,yⱼ) (16)

The evaluation of the intra-task importance of a localizing task will be described below with reference to FIGS. 5C to 5D. The intra-task importance evaluation for a regression-type task is first described with reference to FIG. 5C, for example Smooth L1 is used as a regression loss function. The regression loss function may generally be used to train target localizing as well as target key point localizing. The target localizing comprises 4 task items (x, y, w, h), wherein x and y represent the coordinates of the center point of the localizing target, and w and h represent a length and a width of the localizing target region respectively. The key point localizing contains 2 task items (x, y) for representing coordinate values of the key point, and one target may have multiple key points.

In S6100, a loss function and a loss function value of the regression task are extracted. First, a regression task loss function of all samples is obtained from the network processing result, where the regression task loss function of each sample (e.g., using the SmoothL1 loss function) can be defined as the following Equation (17):

Lᵢ^{reg}(yᵢ,ŷᵢ)=SmoothL1(yᵢ−ŷᵢ) (17)

Wherein yᵢ and ŷᵢ represent an i-th prediction value of the network and a real label, respectively, and the SmoothL1(x) function can be defined as the following Equation (18):

$$SmoothL 1 = \{ \begin{matrix}0.5 {x}^{2} & if \vert x \vert < 1 \\ \vert x \vert - 0.5 & otherwise\end{matrix} , \qquad ( 18 )$$

In step S6200, the importance of regression task of all samples is calculated. In this step, first, the reliability of the classification task is calculated using an exponential function based on the regression task loss function value obtained in step S6100. The reliability is then converted to importance and normalized.

Since the output value of the above function is a continuous real value rather than a probability value, it is converted into a probability value by using an exponential function to measure its reliability through the following Equation (19),

rᵢ^{pos}=e^{-L}^{ᵢ}^{^{reg}} (19)

Then, the reliability is converted into importance Iᵢ^{reg} of the task through the following Equation (20),

Iᵢ^{reg}=1−rᵢ^{reg} (20)

Similarly to the above described embodiment, for example, when there is an error label in the data set of the training network, the importance Iᵢ^{reg} of the task can also be directly represented by the reliability rᵢ^{reg}.

Then, an intra-task normalization process is performed on the importance through the following Equation (21) to obtain I′ᵢ^{reg},

$${I}_{i}^{′ reg} = \frac{{I}_{i}^{r e g}}{\frac{1}{n} {\sum }_{i = 1}^{n} {I}_{i}^{r e g}} \qquad ( 21 )$$

Then, in step S6300, an attention weight is assigned to the regression task loss function. In this step, the importance obtained in the previous step is directly used as a task attention weight and is assigned to the corresponding regression task loss function. Specifically, the importance obtained in step S6200 is assigned to the corresponding task loss function as an attention weight of the task through the following Equation (22), so as to obtain a re-weighted regression loss function:

L_{reg}=Σᵢⁿ⁼¹I′ᵢ^{reg}Lᵢ^{reg} (22)

Where n represents the number of regression tasks.

In another embodiment, for intra-task importance evaluation of the Intersection-over-union task, for example, an Intersection-over-union loss (IoU loss) function may be used. This loss function can be generally used for training target localizing, wherein three tasks (x, y and IoU) are included, x and y represent the coordinates of the center point of the localizing target, IoU represents the intersection proportion of the prediction target region and the real target region, and the larger the intersection proportion is, the more accurate the localizing is. The intra-task importance evaluation of the Intersection-over-union task will be described below with reference to FIG. 5D.

Specifically, first, in step S7100, an Intersection-over-union task loss function and a prediction target region are extracted from the network processing result.

In step S7200, an Intersection-over-union value of the prediction target region and the real target region is calculated. In this step, based on the prediction target region obtained in S7100, an intersection area and a merged area of the prediction target region and the target region in the real label are calculated through the following Equation (23), and then a ratio of the intersection area to the merged area is calculated to obtain the Intersection-over-union value.

$$I o {U}_{i} = \frac{i n t e r ( {B}_{i}^{p red} , {B}_{i}^{g t} )}{union ( {B}_{i}^{p r e d} , {B}_{i}^{g t} )} \qquad ( 23 )$$

Wherein Bᵢ^{pred} and Bᵢ^{gt} respectively represent the i-th prediction target region and the target region in the real label, inter( ) is used for calculating an intersection area between the two target regions, and union ( ) is used for calculating a union of the area of the two target regions. The IoU function can be defined as the following Equation (24):

Lᵢ^{IoU}=−log(IoUᵢ) (24)

In step S7300, a distance between a center position of the prediction target region and a center position of the real target region is calculated.

In this step, based on the prediction target region obtained in step S7100, the coordinates of the center point of the prediction target region are first calculated, and then the distance between the center position of the prediction target region and the center position of the target region in the real label is calculated using the Euclidean metric method. Specifically, the distance between the prediction target center point and the target center point in the real label is calculated by using the Euclidean metric method through the following Equation (25):

Dᵢ^{center}=\sqrt{(cxᵢ^{pref}−cxᵢ^{gt})²+(cyᵢ^{pred}−cyᵢ^{gt})²} (25)

Wherein, cxᵢ^{pred} and cxᵢ^{gt} respectively represent the x-axis coordinate values of the center point of the i-th prediction target and the target in the real label, and cyᵢ^{pred} and cyᵢ^{gt} respectively represent the y-axis coordinate values of the prediction target and target in the real label.

Then, in step S7400, the importance of Intersection-over-union task of all samples is calculated. Specifically, based on the Intersection-over-union value IoUᵢ obtained in step S7200 and the center point distance Dᵢ^{center} obtained in step S7300, the importance of the Intersection-over-union task is calculated by using an exponential function through the following Equation (26), and is normalized:

Iᵢ^{IoU}=1−e^{-(-1-IoU}^{ᵢ}^{+D}^{ᵢ}^{^{center}}⁾ (26)

Then, intra-task normalization is performed on the importance through the following Equation (27) to obtain I′ᵢ^{IoU}:

$${I}_{i}^{′ IoU} = \frac{{I}_{i}^{IoU}}{\frac{1}{n} {\sum }_{i = 1}^{n} ( {I}_{i}^{IoU} )} \qquad ( 27 )$$

Where n represents the number of tasks.

Then, in step S7500, an attention weight is assigned to the Intersection-over-union task loss function. In this step, the importance of the Intersection-over-union task obtained in the previous step is used as an attention value of the Intersection-over-union task, and the value is assigned to the corresponding task loss function to obtain a re-weighted Intersection-over-union loss function. Specifically, the importance obtained is assigned to the corresponding task loss function as the attention weight of the task through the following Equation (28) to obtain the re-weighted Intersection-over-union loss function:

L_{loc}=Σᵢⁿ⁼¹I′ᵢ^{IoU}Lᵢ^{IoU} (28)

The inter-task importance evaluation will be described below with reference to FIG. 6A, and the inter-task importance evaluation is mainly to evaluate the importance between different tasks within same sample. The implementation can adaptively adjust the attention values of different tasks in the network training process, so that the network focuses on training important tasks. Taking target detection as an example, it includes a classification task and a localizing task.

First, in steps S8100 and S8200, a classification task loss function and a loss function value, and a localizing task loss function and a loss function value are extracted from the network processing result, respectively. The loss functions of the classification task and the localizing task are respectively defined as Lᵢ^{cls} (pᵢ,yᵢ) and Lᵢ^{loc}(oⱼ,ôⱼ), wherein pᵢ and yᵢ respectively represent a prediction value of the i-th classification task and a classification value in the real label, and oⱼ and ôⱼ represent a prediction value of the j-th localizing task and a localizing value in the real label.

In steps S8300 and S8400, the classification task loss function values and the localizing task loss function values are normalized or standardized, respectively, based on all the classification task loss function values and the localizing task loss function values obtained in steps S8100 and S8200. Specifically, the loss function values of the classification task and the localizing task are normalized through the following Equations (29) and (30), respectively, to ensure that the dimensions of the loss function values of different tasks are consistent.

$${L}_{i}^{′ cls} = \frac{{L}_{i}^{cls} - min ( {L}^{cls} )}{max ( {L}^{cls} ) - min ( {L}^{cls} )} \qquad ( 29 )$$

$${L}_{j}^{′ loc} = \frac{{L}_{j}^{loc} - min ( {L}^{l o c} )}{max ( {L}^{loc} ) - min ( {L}^{loc} )} \qquad ( 30 )$$

Wherein max (x) function calculates the maximum value in x, min (x) function calculates the minimum value in x, or the loss function values of the classification task and the localizing task are normalized through the following Equations (31) and (32), respectively,

$${L}_{i}^{′ cls} = \frac{{L}_{i}^{cls} - {μ}^{cls}}{{σ}^{cls}} \qquad ( 31 )$$

$${L}_{j}^{′ loc} = \frac{{L}_{j}^{loc} - {μ}^{loc}}{{σ}^{cls}} \qquad ( 32 )$$

Wherein, μ^{cis} and σ^{cis} respectively represent a mean value and a variance of all classification task loss function values, and v and a respectively represent a mean value and a variance of all localizing task loss function values.

S8500: calculating the inter-task importance.

Inter-task importance is calculated based on a processed classification task loss function value obtained in S8300 and a processed localizing task loss function value obtained in S8400. Since the classification task loss function value and the localizing task loss function value are consistent in dimension, they can be placed in the same space to evaluate the importance.

Then, importance Iᵢ^{cls} is and Iⱼ^{loc} are calculated based on the normalized classification task and localizing task through the following Equations (33) and (34):

Iᵢ^{cls}=1−e^{-L}^{ᵢ}^{^{′cls}} (33)

Iⱼ^{loc}=1−e^{-L}^{ⱼ}^{^{′loc}} (34)

Similarly to the above described embodiment, for example, when there is an error label in the data set of the training network, the importance Iᵢ^{cls} and Iⱼ^{loc} of the tasks can also be directly represented by e^{-L}^{ᵢ}^{^{′cls}} and e^{-L}^{ⱼ}^{^{′loc}}.

Then, an inter-task normalization process is performed on the importance Iᵢ^{cls} and Iⱼ^{loc} through the following Equations (35) and (36) to obtain cᵢ^{cls} and cⱼ^{loc}.

$${c}_{i}^{c l s} = \frac{{I}_{i}^{cls}}{\frac{1}{n + m} ( {\sum }_{i = 1}^{n} {I}_{i}^{cls} + {\sum }_{j = 1}^{m} {I}_{j}^{loc} )} \qquad ( 35 )$$

$${c}_{j}^{loc} = \frac{{I}_{j}^{loc}}{\frac{1}{n + m} ( {\sum }_{i = 1}^{n} {I}_{i}^{cls} + {\sum }_{j = 1}^{m} {I}_{j}^{loc} )} \qquad ( 36 )$$

Then, in step S8600 and step S8700, the classification task importance obtained in step S8500 is assigned to the corresponding classification task loss function as an attention value, and the localizing task importance obtained in step S8500 is assigned to the corresponding localizing task loss function as an attention value, respectively. Specifically, the normalized importance is assigned as an attention weight to the corresponding classification task loss function and localizing task loss function through the following Equation (37), so as to obtain a re-weighted multitask loss function.

L=Σᵢ₌₁ⁿcᵢ^{cls}Lᵢ^{cls}(pᵢ,yᵢ)+Σⱼ₌₁^{m}cⱼ^{loc}Lᵢ^{loc}(oⱼ,ôⱼ) (37)

In step S8800, the re-weighted multitask loss function is output. Specifically, the classification task loss function obtained after being assigned a value in S8600 and the localizing task loss function obtained after being assigned a value in S8700 are combined to obtain the multitask loss function, and the loss function is output.

The implementation can adaptively adjust the attention among different tasks, so that the network pays more attention to the training of important tasks, thereby improving the network performance.

The evaluation of the importance of a task by combining the inter-task importance evaluation with the intra-task importance evaluation will be described below with reference to FIG. 6B. This implementation not only takes into account the difference of inter-task importance to adaptively adjust the attention weights among different tasks, but also takes into account the difference of the same task across different samples, so that the network can analyze the importance of the tasks more comprehensively from the local and global perspectives. Taking target detection as an example, it includes a classification task and a localizing task.

In steps S9100 and S9200, similarly to in steps S8100 and S8200, a classification task loss function and a loss function value and a localizing task loss function and a loss function value are extracted. The loss functions of the classification task and the localizing task are respectively defined as Lᵢ^{cls}(pᵢ,yᵢ) and Lᵢ^{loc} (oⱼ,ôⱼ), wherein pᵢ and yᵢ respectively represent a prediction value of the i-th classification task and a classification value in the real label, and oⱼ and ôⱼ represent a prediction value of the j-th localizing task and a localizing value in the real label.

In steps S9300 and S9400, similarly to in steps S8300 and S8400, the classification task loss function values and the localizing task loss function values are normalized or standardized, respectively, through the following Equations (38) and (39) so as to ensure that the dimensions of different task loss function values are consistent:

$${L}_{i}^{′ cls} = \frac{{L}_{i}^{cls} - min ( {L}^{cls} )}{max ( {L}^{cls} ) - min ( {L}^{cls} )} \qquad ( 38 )$$

$${L}_{j}^{′ loc} = \frac{{L}_{j}^{loc} - min ( {L}^{l o c} )}{max ( {L}^{loc} ) - min ( {L}^{loc} )} \qquad ( 39 )$$

Wherein max (x) function calculates the maximum value in x, min (x) function calculates the minimum value in x, or the loss function values of the classification task and the localizing task are normalized through the following Equations (40) and (41), respectively,

$${L}_{i}^{′ cls} = \frac{{L}_{i}^{cls} - {μ}^{cls}}{{σ}^{cls}} \qquad ( 40 )$$

$${L}_{j}^{′ loc} = \frac{{L}_{j}^{loc} - {μ}^{loc}}{{σ}^{cls}} \qquad ( 41 )$$

Wherein, μ^{cls} and σ^{cls} respectively represent a mean value and a variance of all classification task loss function values, and μ^{loc} and σ^{loc} respectively represent a mean value and a variance of all localizing task loss function values.

In step S9500, the inter-task importance is calculated similarly as in step S8500. Specifically, the inter-task importance is evaluated based on the classification task loss function value obtained in step S9300 and the localizing task loss function value obtained in step S9400 while placing them in the same space.

In step S9600, the intra-task importance is calculated. Specifically, the intra-classification task importance and the intra-localizing task importance are calculated respectively based on the classification task loss function value obtained in step S9300 and the localizing task loss function value obtained in step S9400.

Then, in step S9700, the importance of the task is calculated. Specifically, the inter-task importance and the intra-task importance obtained in S9500 and S9600 are combined in a weighted manner to obtain the final task importance. Importances Iᵢ^{cls} and Iⱼ^{loc} are calculated based on the normalized classification task and localizing task through the following Equations (42) and (43):

Iᵢ^{cls}=1−e^{-L}^{ᵢ}^{^{′cls}} (42)

Iⱼ^{loc}=1−e^{-L}^{ⱼ}^{^{′loc}} (43)

Similarly to the above described embodiment, for example, when there is an error label in the data set of the training network, the importances Iᵢ^{cls} and Iⱼ^{loc} of the tasks can also be directly represented by e^{-L}^{ᵢ}^{^{′cls}} and e^{-L}^{ⱼ}^{^{′loc.}}

Then, an inter-task normalization process is performed on the importances Iᵢ^{cls} and Iⱼ^{loc} through the following Equations (44) and (45):

$${c}_{i}^{c l s} = \frac{{I}_{i}^{cls}}{\frac{1}{n + m} ( {\sum }_{i = 1}^{n} {I}_{i}^{cls} + {\sum }_{j = 1}^{m} {I}_{j}^{loc} )} \qquad ( 44 )$$

$${c}_{j}^{loc} = \frac{{I}_{j}^{loc}}{\frac{1}{n + m} ( {\sum }_{i = 1}^{n} {I}_{i}^{cls} + {\sum }_{j = 1}^{m} {I}_{j}^{loc} )} \qquad ( 45 )$$

Meanwhile, an intra-task normalization process is performed on the importances Iᵢ^{cls} and Iⱼ^{loc} through the following Equations (46) and (47):

$${c}_{i}^{′ cls} = \frac{{I}_{i}^{cls}}{\frac{1}{n} {\sum }_{i = 1}^{n} {I}_{i}^{cls}} \qquad ( 46 )$$

$${c}_{j}^{′ loc} = \frac{{I}_{j}^{loc}}{\frac{1}{m} {\sum }_{j = 1}^{m} {I}_{j}^{loc}} \qquad ( 47 )$$

In step S9810 and step S9820, similarly as in step S8600 and step S8700, a re-weighted multitask loss function is output, respectively. Specifically, the inter-task importance and the intra-task importance are weighted as attention weights of tasks and assigned to the corresponding classification task loss function and localizing task loss function through the following Equation (48), to obtain the re-weighted multitask loss function.

L=Σᵢ₌₁ⁿ(αcᵢ^{cls}+(1−α)c′ᵢ^{cls})Lᵢ^{cls}(pᵢ,yᵢ)+Σⱼ₌₁^{m}(αcⱼ^{loc}+(1−α)c′ⱼ^{loc})Lᵢ^{loc}(oⱼ,ôⱼ) (48)

Where α represents a balancing factor to balance the influences of inter-task and intra-task attention.

At step S9900, the re-weighted multitask loss function is output, similarly to in step S8800.

FIG. 6C illustrates an example of combining intra-task and inter-task importance evaluations. 601 shows tasks in three samples in the image data, the tasks of sample 1, sample 2 and sample 3 in the image data are represented by a bar pattern, a mosaic pattern and a diamond grid pattern, respectively, the tasks of different types, such as a classification task, a localizing task, a key point detection task, are represented by a triangular frame, a quadrangular frame and a pentagonal frame, respectively, respective tasks in the same type are represented by a dashed line, a dotted line and a solid line, respectively, and the attention weights of the tasks in 602 are represented by different gray scales. As shown in FIG. 6C, after the inter-task and intra-task importance evaluations are performed, different attention weights (different gray scales) are given to the respective tasks.

This embodiment combines the inter-task importance evaluation with the intra-task importance evaluation to evaluate the importances of the tasks, which can adaptively adjust the attention among different tasks, and meanwhile, it can also take into account the difference of the same task across different samples, so that the network can pay attention to the training of important tasks from the local and global perspectives, thereby improving the network performance.

The present embodiment is applied to the processing result of the network, i.e., re-weights the loss function in the processing result of the network, and then trains the network with the re-weighted loss function. That is, the neural network is trained with the re-weighted loss function and the parameters are optimized. The method of the embodiment enables the network to pay attention to the difference of importance of the tasks of the samples, instead of using the samples as a unit to evaluate the importance, which can further improve the accuracy of the network.

### Modification Example 1

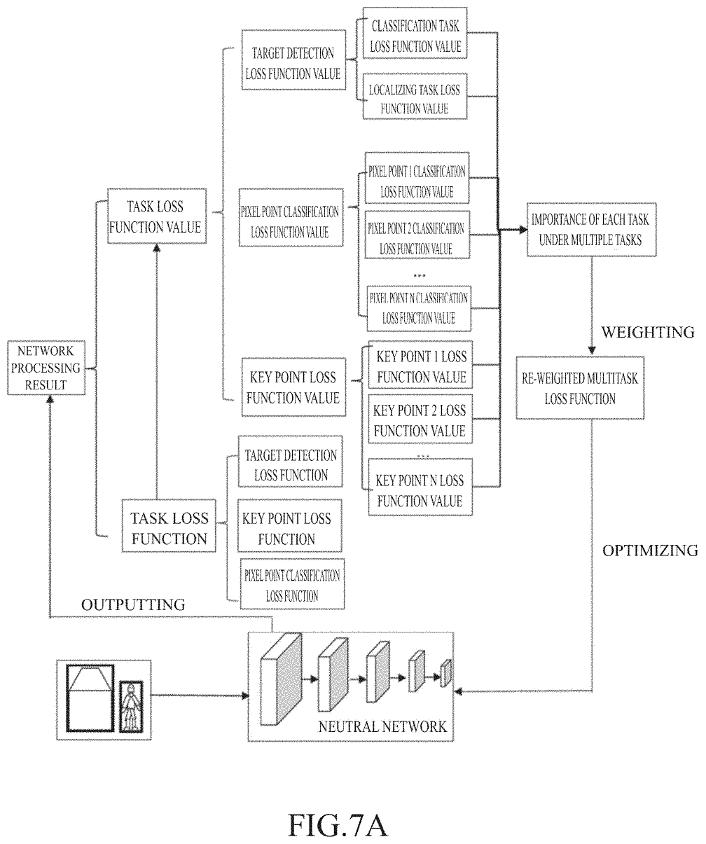

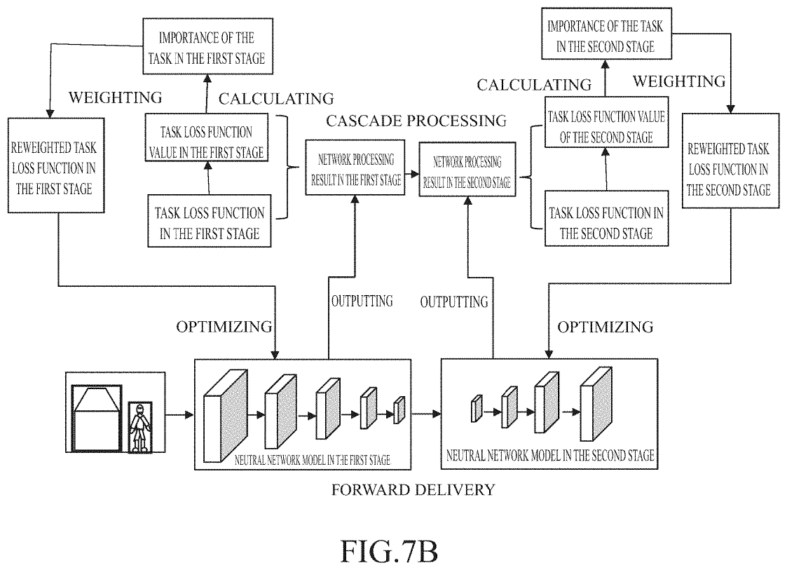

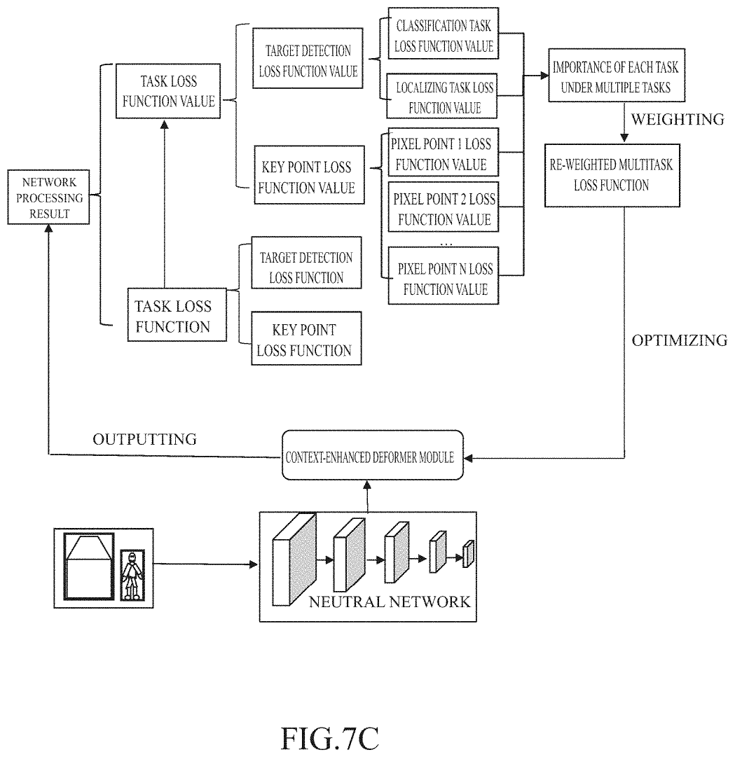

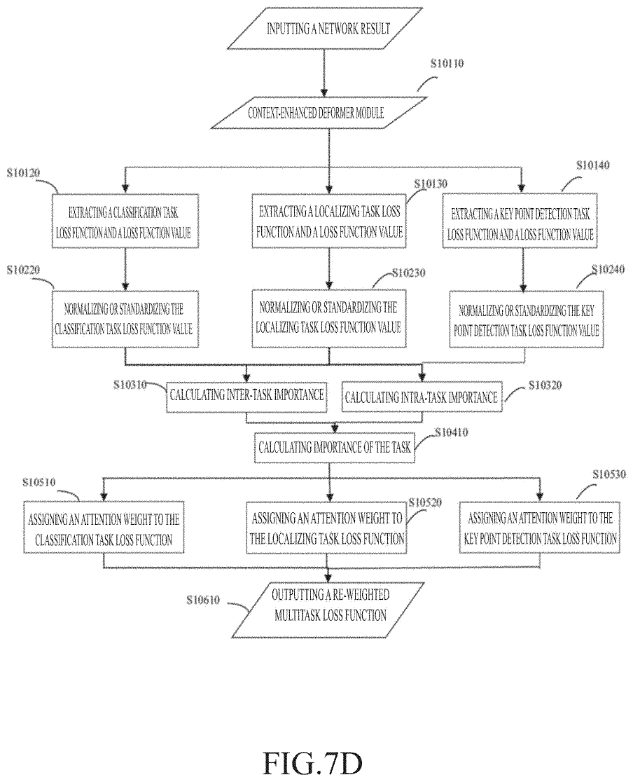

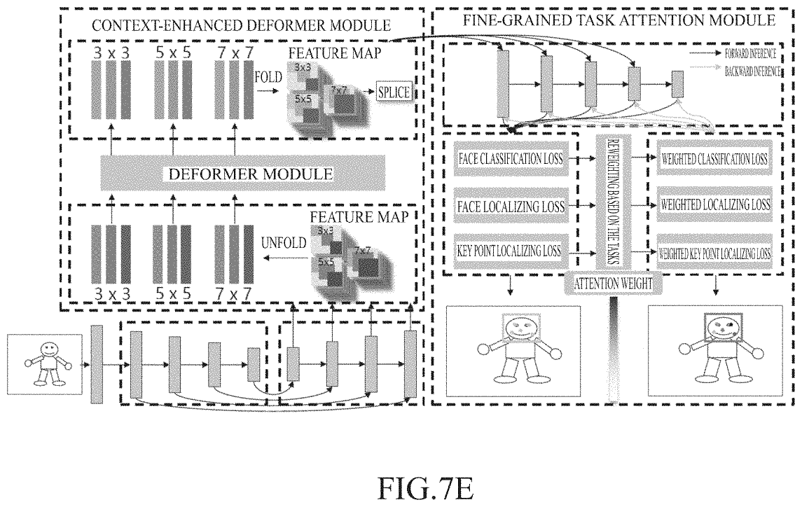

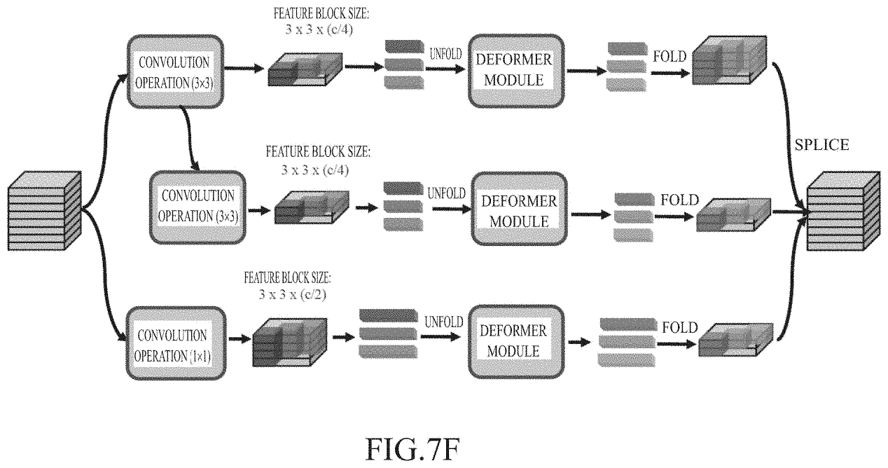

An embodiment in which the above method is applied to a multitask integrated network will be described below with reference to FIG. 7A. The neural network optimization process shown in FIG. 7A is different from the neural network optimization process shown in FIG. 3B in that, for example, one network simultaneously includes tasks of object detection, object key point detection, semantic segmentation and the like.

In the network output stage, a plurality of different task outputs are simultaneously contained in the multitask network, so that integration of tasks is realized. Specifically, first, a processing result of a multitask network is obtained. Then, importance evaluation is performed on each task under multiple tasks from the processing result of the neural network. Specifically, for example, a classification task and a localizing task in target detection, a key point localizing task in target key point detection, and a pixel point classification task in semantic segmentation are used together as comparison targets to analyze the importance thereof. Since there are differences among the tasks, whether in output form or in loss function, it is necessary to unify the outputs of the multiple tasks in dimension, that is, to perform standardization and normalization processing by using the method described above.

And then, an attention weight is assigned to the task loss function in the network processing result, specifically, the importance of task under different tasks is used as the attention weight and is assigned to the loss function of each task under the corresponding multiple tasks in the network processing result.

And then, the neural network is trained by using a re-weighted loss function, and the parameters are optimized until the network training termination condition is satisfied, and a network model is output.

According to the present embodiment, the multitask network training optimizes the parameters of the network by using the loss functions of a plurality of tasks so as to improve the performance of the tasks. For example, if the same network is expected to be able to perform face localizing according to the input image and be able to detect face key points at the same time. In this case, the neural network has two related tasks, one is a classification task and the other is a regression task, and according to the above training method, the importances of the classification task and the regression task are evaluated respectively, and the corresponding loss functions are re-weighted to optimize the network, so that the network accuracy can be further improved.

### Modification Example 2

An exemplary embodiment in which the above method is directly applied to a processing result of a task cascade network will be described below with reference to FIG. 7B. The task cascade network according to this embodiment is a network having outputs of a plurality of stages, and a processing result of a subsequent stage is obtained by processing based on a processing result of a previous stage.

The neural network optimization process shown in FIG. 7B is different from the neural network optimization process shown in FIG. 3B in that the neural network has a plurality of stages, for example, two stages or more, and in the present embodiment, the neural network processing result of the second stage is obtained based on the neural network processing result of the first stage. Specifically, first, a processing result of each stage of the neural network is obtained. And then, cascade processing is carried out on the processing result of each stage of the network to obtain the final output results of the respective stages. Since the processing results of the respective stages are correlated, and the processing result of the subsequent stage is further processed based on the processing result of the previous stage to obtain the final output result, this step is to perform cascade processing on the processing result obtained in each stage to obtain the final processing result in the stage. Then, the importance of the task of each stage is evaluated based on the results after the cascade processing of the respective stages. And secondly, the importances of the tasks are assigned to the task loss functions corresponding to different stages as attention weights of the task loss functions. The neural network is then trained with the re-weighted loss functions and the parameters are optimized.

And then it is determined whether the network training meets termination conditions, such as whether the iteration number of the training reaches a predetermined value, whether the loss value of the training is lower than a preset threshold, etc. If the conditions are not met, the task importance is re-evaluated according to the network processing result of the current state, and network training is carried out. And if the conditions are met, the network model in the current state is stored and the model is output.

### Modification Example 3

An embodiment in which the above method is applied to a multitask face detection network with context-enhanced deformer module will be described below with reference to FIGS. 7C-7F, the neural network structure shown in FIG. 7C differs from the neural network structure shown in FIG. 7A in that, for example, a context-enhanced deformer module is added after the network result is output, and before the task loss function is extracted and the task loss function value is calculated, and the neural network shown in FIG. 7C includes the tasks of face classification, face localizing, and face key point detection.

FIG. 7E illustrates a specific example according to this exemplary embodiment. In the network forward inference stage, a feature map in the network is subjected to feature enhancement through the context-enhanced deformer module. Specifically, as shown in FIG. 7F, a feature map of the network middle layer is obtained, the feature map is then partitioned according to a preset size to obtain a plurality of feature vectors, the feature vectors are sent to a deformer to calculate attention weights among different feature vectors, then the attention weights are assigned to corresponding feature vectors, and finally these feature vectors are recombined into the shape of the original feature map to obtain a feature-enhanced feature map, which is sent to a subsequent network inference stage. The deformer module operates as follows:

Tᵢ=F_{unfold}(F_{conv}_{ᵢ}(fpₗ)),i=1 . . . b (49)

Tᵢ′=MLP(MSA(Tᵢ)) (50)

Tᵢ″=F_{fold}(Tᵢ′) (51)

y=F_{concat}([T₁″, . . . ,T_{b}″])) (52)

Where fpₗ represents a feature map output at the first stage, b is the number of convolution operations with different kernels, 1×1, 3×3, and 5×5 convolutions (two 3×3 convolutions) are used to extract a feature pyramid, F_{unfold} is used to partition and unfold the feature map, and F_{fold} is used to merge and fold the feature map. MLP denotes a multi-layer perceptron, MSA is a multi-head self-attention deformer unit.

A specific process will be described below with reference to FIG. 7D. In the network output stage, the multitask network of the present exemplary embodiment includes a plurality of different task outputs, thereby realizing task integration. Specifically, an output result of a multitask network is obtained first. In step S10110, the network output is processed by the context-enhanced deformer module. Then, the importance of each task under the multiple tasks is evaluated. Specifically, in the embodiment, the face detection network includes face classification, face localizing, and face key point detection. The multitask loss L is defined by the following Equation (53):

L=L_{cls}+L_{loc}+L_{land} (53)

Wherein L_{cls} represents a face classification loss function using cross entropy loss as shown in Equation (1), pᵢ represents a prediction probability value of the i-th face area, and 1−pⱼ represents a prediction probability value of the j-th non-face area. L_{loc} and L_{land} represent the face localizing loss function and the face key point detection loss function, respectively, as shown in Equation (18) of SmoothL1 loss function. Wherein, L_{i,m}^{loc} represents the m-th term of the localizing loss function in the i-th face, and L_{i,n,m}^{landm} represents the m-th term of the loss function of the j-th key point in the i-th face.

Specifically, first in steps S10120, S10130, and S10140, a classification task loss function and a function value, a localizing task loss function and a loss function value, and a key point detection task loss function and a loss function value are extracted from the results of processing by the context deformer module, respectively, and based on the obtained prediction probability values pᵢ and 1−pⱼ of the face area and the non-face area, the face localizing loss function value L_{i,m}^{loc}, and the face key point detection loss function value L_{i,j,m}^{landm}, pᵢ and 1−pⱼ are directly used as classification task reliabilities of the face area and the non-face area, respectively. Because the output of the face localizing loss function and the face key point detection loss function are continuous real values, rather than probability values, they are converted into probability values through the following Equations (54) and (55) functions to measure the reliability thereof:

r_{i,m}^{loc}=e^{(-l}^{_{i,m}}^{^{loc}}⁾ (54)

r_{i,n,m}^{land}=e^{(-l}^{_{i,n,m}}^{^{land}}⁾ (55)

Then, in steps S10200, S10230, S10240 and S10310, the intra-task normalization is performed through following Equations (56), (57), (58) and (58) to obtain the face area classification intra-task importance Iᵢ′^{pos} the non-face area classification intra-task importance Iᵢ′^{neg}, the face localizing intra-task importance I_{i,m}′^{loc}, and the face key point detection intra-task importance I_{i,n,m}′^{land}:

$${I}_{i}^{′ pos} = \frac{1 - {p}_{i}}{\frac{1}{{N}_{P o s} + {N}_{N e g}} [ {\sum }_{i ∈ Pos} ( 1 - {p}_{i} ) + {\sum }_{j ∈ Neg} {p}_{j} ]} \qquad ( 56 )$$

$${I}_{j}^{′ neg} = \frac{{p}_{j}}{\frac{1}{{N}_{P o s} + {N}_{N e g}} [ {\sum }_{i ∈ Pos} ( 1 - {p}_{i} ) + {\sum }_{j ∈ Neg} {p}_{j} ]} \qquad ( 57 )$$

$${I}_{i , m}^{′ loc} = \frac{1 - {r}_{i , m}^{loc}}{\frac{1}{{N}_{POS} {M}_{loc}} {\sum }_{∈ Pos} {\sum }_{m = 1}^{{M}_{loc}} ( 1 - {r}_{i , m}^{loc} )} \qquad ( 58 )$$

$${I}_{i , n , m}^{′ land} = \frac{1 - {r}_{i , n , m}^{land}}{\frac{1}{{N}_{POS} {N}_{land} {M}_{land}} {\sum }_{i ∈ Pos} {\sum }_{n = 1}^{{N}_{land}} {\sum }_{m = 1}^{{M}_{land}} ( 1 - {r}_{i , n , m}^{land} )} \qquad ( 59 )$$

Wherein M_{loc} represents the number of the face localizing loss function items, M_{land} represents the number of the face key point localizing loss function items, and N_{land} represents the number of key points in one face.

And, in S10200, S10230, S10240 and S10320, the inter-task normalization processing is performed through the following Equations (60), (61), (62) and (63) to obtain the face area classification inter-task importance Iᵢ″^{pos}, the face localizing inter-task importance I_{i,m}″^{loc}, the face key point detection inter-task importance I_{i,n,m}″^{land}:

$${I}_{i}^{″ pos} = \frac{1 - {p}_{i}}{{c}_{i}} \qquad ( 60 )$$

$${I}_{i , m}^{″ loc} = \frac{1 - {r}_{i , m}^{loc}}{{c}_{i}} \qquad ( 61 )$$

$${I}_{i , n , m}^{″ land} = \frac{1 - {r}_{i , n , m}^{land}}{{c}_{i}} \qquad ( 62 )$$

$${c}_{i} = \frac{{\sum }_{i ∈ Pos} [ ( 1 - {p}_{i} ) + {\sum }_{m = 1}^{{M}_{loc}} ( 1 - {r}_{i , m}^{loc} ) + {\sum }_{n = 1}^{{N}_{land}} {\sum }_{m = 1}^{{M}_{land}} ( 1 - {r}_{i , n , m}^{land} ) ]}{{N}_{p o s} ( 1 + {M}_{loc} + {N}_{land} {M}_{land} )} \qquad ( 63 )$$

Where cᵢ represents the average importance of all tasks in the i-th sample.

In step S10410, the intra-task importance and the inter-task importance are weighted through the following Equations (64), (65), and (66), and then the weighted task importances are taken as the attention weights of the classification task, the localizing task, and the key point detection task:

wᵢ^{pos}=αlᵢ′^{pos}+(1−α)Iᵢ′^{pos} (64)

w_{i,m}^{loc}=αI_{i,m}′^{loc}+(1−α)I_{i,m}″^{loc} (65)

w_{i,n,m}^{land}=αI_{i,n,m}′^{land}+(1−α)I_{i,n,m}″^{land} (66)

Where a represents a balancing factor to balance the influence of inter-task attention and intra-task attention. For the non-face area sample, only classification task optimization is carried out, and localizing and key point detection task optimization are not carried out, so that Iⱼ′^{neg} is directly used as the weight wⱼ^{neg}.

Finally, in steps S10510, S10520, and S10530, the obtained weights are assigned to the corresponding classification task loss function, localizing task loss function and key point detection task loss function through the following Equations (67), (68), and (69) to obtain a re-weighted multitask loss function:

$${L}_{c l s} = - \frac{1}{{N}_{p o s}} [ {\sum }_{i ∈ P o s} {w}_{i}^{p o s} log {p}_{i} + {\sum }_{j ∈ Neg} {w}_{j}^{n e g} log ( 1 - {p}_{j} ) ] \qquad ( 67 )$$

$${L}_{l o c} = \frac{1}{{N}_{p o s}} {\sum }_{∈ Pos} {\sum }_{m = 1}^{{M}_{loc}} {w}_{i , m}^{loc} {l}_{i , m}^{loc} \qquad ( 68 )$$

$${L}_{l a n d} = \frac{1}{{N}_{p o s}} {\sum }_{i ∈ P o s} {\sum }_{n = 1}^{{N}_{land}} {\sum }_{m = 1}^{{M}_{land}} {w}_{i , n , m}^{land} {l}_{i , n , m}^{land} \qquad ( 69 )$$

In step 10610, the re-weighted multi-task loss function is output, similarly to in S9900.

As described above, in this embodiment, a deformer module is added to the neural network, so that the expression on the features by the neural network can be enhanced, the robustness of the features can be improved, and the accuracy of the network can be further improved.

As described above, according to the first exemplary embodiment, the attention can be adaptively adjusted in unit of task for the samples, rather than in unit of sample itself, which makes the network pay more attention to the training of important tasks, thereby further improving the network performance.

Table 1 shows a comparison in performance of the technique in the non-patent document “Prime Sample Attention in Object Detection” with the method according to the present disclosure on a WiderFace data set. Therefore, as described above, the training method of the neural network according to the present disclosure can consider the importance of each task of the sample in a finer granularity, so that the attention weight of each task can be adaptively adjusted in the network training, thereby further improving the performance of the network.

TABLE 1

| Method | Easy | Medium | Difficult |
|---|---|---|---|
| Baseline | 94.1 | 92.2 | 88.4 |
| Prior Art | 94.8 (0.7%↑) | 93.4 (1.2% ↑) | 89.8 (1.4% ↑) |
| The present disclosure | 95.5 (1.4% ↑) | 94.1 (1.9% ↑) | 90.5 (2.1% ↑) |

### Second Exemplary Embodiment

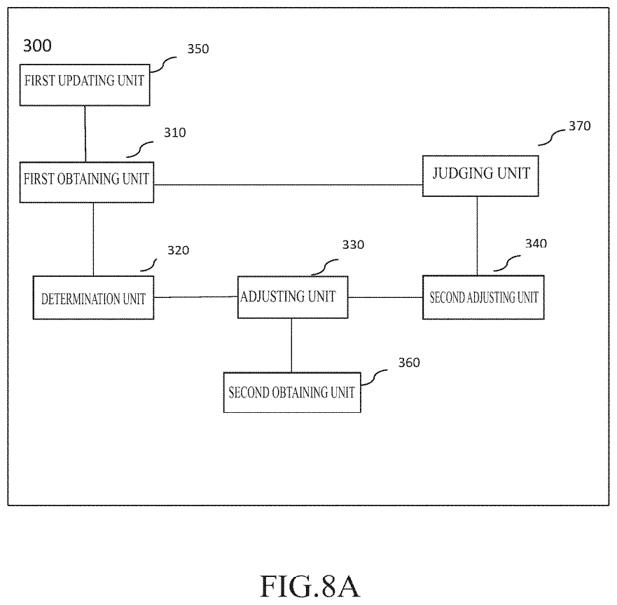

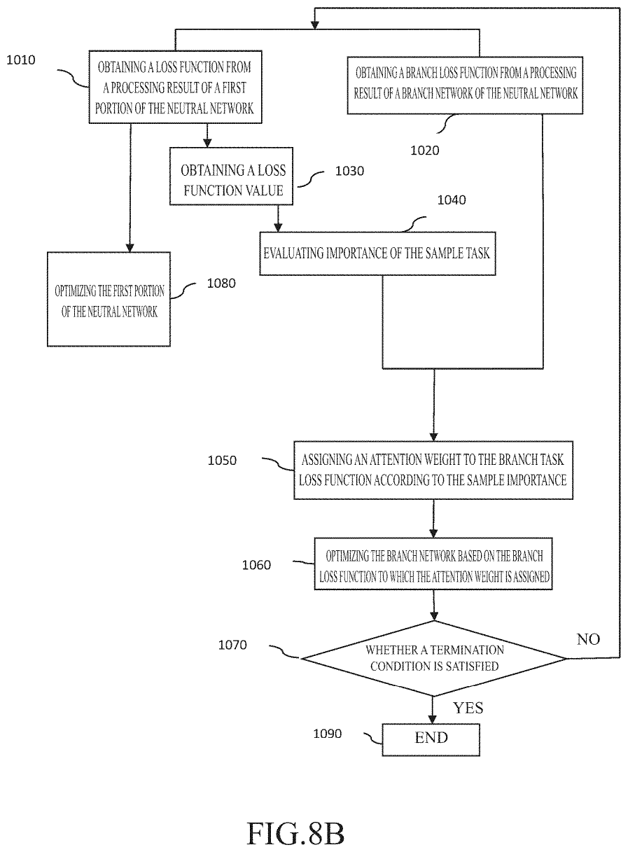

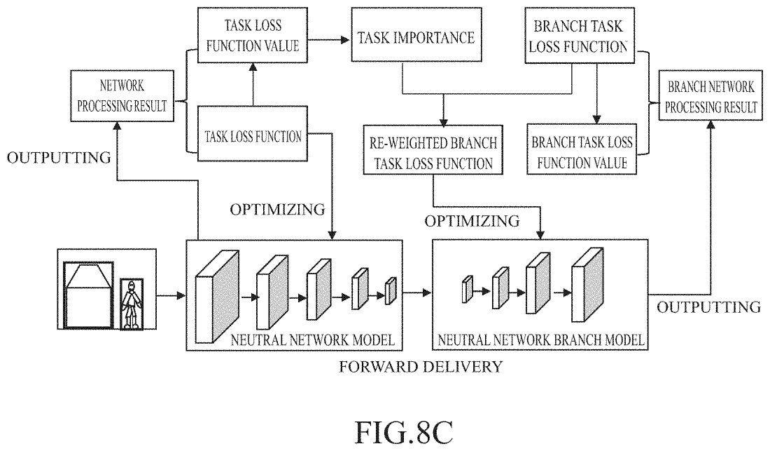

An exemplary embodiment in which an additional branch network is added to the neural network will be described below with reference to FIGS. 8A-8C. In this exemplary embodiment, portions different from those of the first exemplary embodiment will be described with emphasis, and portions identical or similar to those of the first exemplary embodiment will be briefly described or omitted.

FIG. 8A shows a structure diagram of a neural network training device 300 according to this embodiment. Where some or all of the modules shown in FIG. 8A may be implemented by dedicated hardware. As shown in FIG. 8A, the training device 300 includes a first obtaining unit 310, a determination unit 320, an adjusting unit 330, an updating unit 340, and a second obtaining unit 350.

The neural network optimization process according to FIG. 8C differs from the neural network optimization process shown in FIG. 3B in that the neural network of the present embodiment includes two portions, the first portion is similar to the neural network in the first exemplary embodiment, and on the basis of the first portion, a branch network is added as a second portion of the neural network to be responsible for assigning attention weight to the task loss function, instead of directly assigning attention weight to the loss function in the original processing result of the network.

Specifically, in steps S1010 to S1030, the first obtaining unit 310 and the second obtaining unit 360 first extract the task loss function and the task loss function value of each portion from the network processing results of the first portion and the second portion of the neural network, respectively. Then, in step S1040, the determination unit 320 calculates the importance of the task based on the task loss function value of the first portion of the neural network. Next, in step S10500, the adjusting unit 330 assigns the importance as a task attention weight to a corresponding task loss function in the processing result of the branch network as the second portion of the neural network based on the calculated task importance (the tasks in the additional branch and the original processing results are in a one-to-one correspondence, but the results may be different).

Then, in step S1080 and in step S1060, the second updating unit 340 and the first updating unit 350 train the network and optimize the network parameters based on the obtained re-weighted task loss function together with the unweighted loss function. Specifically, in step S1080, the second updating unit 360 optimizes the first portion of the neural network using the unweighted loss function, and in step S1060, the first updating unit 340 optimizes the branch network of the neural network based on the re-weighted loss function. In step S1070, similarly to the first exemplary embodiment, it is determined whether or not a training termination condition is satisfied, and in the case where the training termination condition is satisfied, the training process is ended in step S1090, and a network model is output.

According to this exemplary embodiment, on the basis of the neural network training method of the first exemplary embodiment, training of the original distribution loss function is reserved, so that the neural network training method of this exemplary embodiment can also give consideration to training of common tasks while focusing on the training of difficult tasks, which contributes to further improvement of network performance.

### Modification Example 1

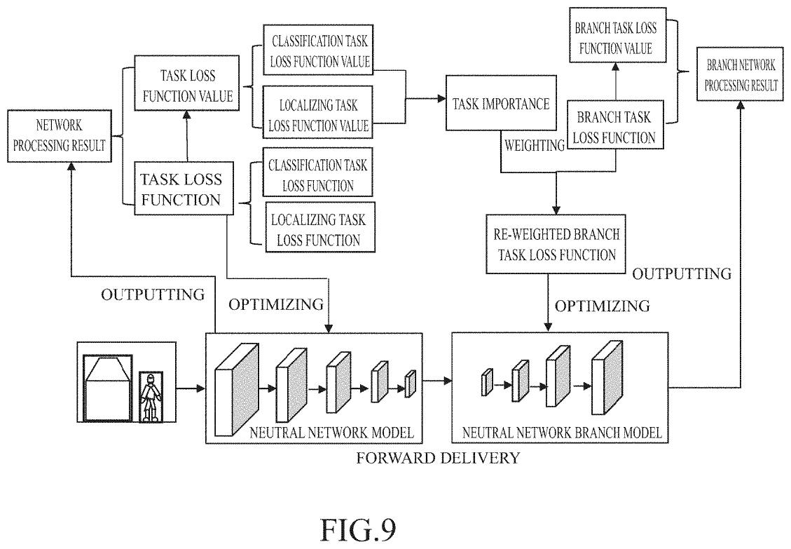

This embodiment is based on the neural network training method shown in FIG. 8C, and the method is used in a target detection task. The following will be described in detail with reference to FIG. 9.

First, a processing result of a first portion of a target detection neural network and a processing result of a branch network of a second portion are obtained. Then, the importances of the classification task and the localizing task in the processing result of the first portion of the neural network are evaluated. Because the target detection comprises two tasks, i.e., object classification and object localizing, the importances of these tasks need to be evaluated.

Then, the importances of the classification and localizing tasks are used as attention weights of the classification and localizing task loss functions, respectively, and are assigned to the corresponding classification and localizing task loss functions in the processing result of the branch network as the second portion of the neural network.

The neural network is then trained with the unweighted loss function in the processing result of the first portion of the neural network together with the re-weighted loss function in the processing of the branch network of the second portion of the neural network, and parameters are optimized. Specifically, the first portion of the neural network is optimized with the unweighted loss function, and the branch network in the neural network is optimized based on the re-weighted loss function. Similarly to the first exemplary embodiment, it is determined whether or not a training termination condition is satisfied, and in the case where the training termination condition is satisfied, the training process is ended, and a network model is output.

### Modification Example 2

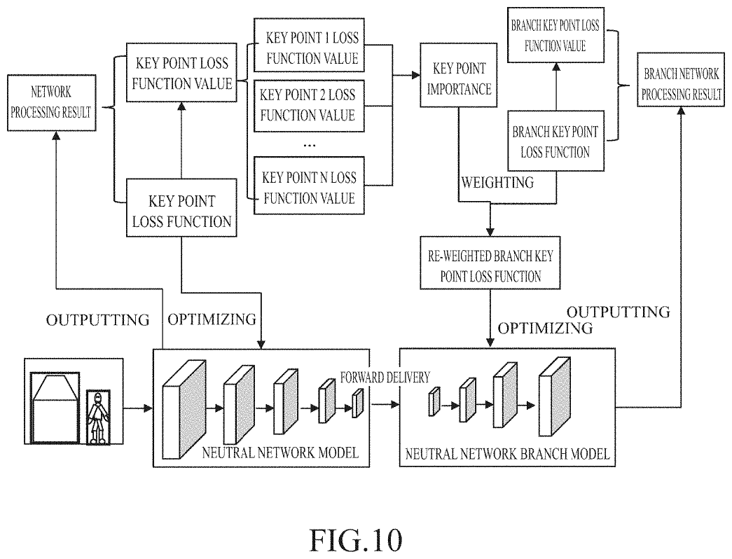

This embodiment is based on the neural network training method shown in FIG. 8C, and the method is used in a target key point detection task. The following will be described in detail with reference to FIG. 10.

First, a processing result of a first portion of a target key point detection neural network and a processing result of a branch network of a second portion are obtained. Then, in the processing result, the importance of each key point (task) is evaluated. Since the target key point detection includes multiple key point locations, the importance of each key point needs to be evaluated separately.

Then, the importance of the key point is taken as an attention weight of the key point loss function, and is assigned to the corresponding key point loss function in the branch processing result of the second portion of the neural network.

The neural network is then trained with the unweighted loss function in the processing result of the first portion of the neural network together with the re-weighted loss function in the branch result of the second portion of the neural network, and parameters are optimized. Specifically, the first portion of the neural network is optimized with an unweighted loss function, and the branch network in the neural network is optimized based on the re-weighted loss function. Similarly to the first exemplary embodiment, it is determined whether or not a training termination condition is satisfied, and in the case where the training termination condition is satisfied, the training process is ended, and a network model is output.

### Modification Example 3

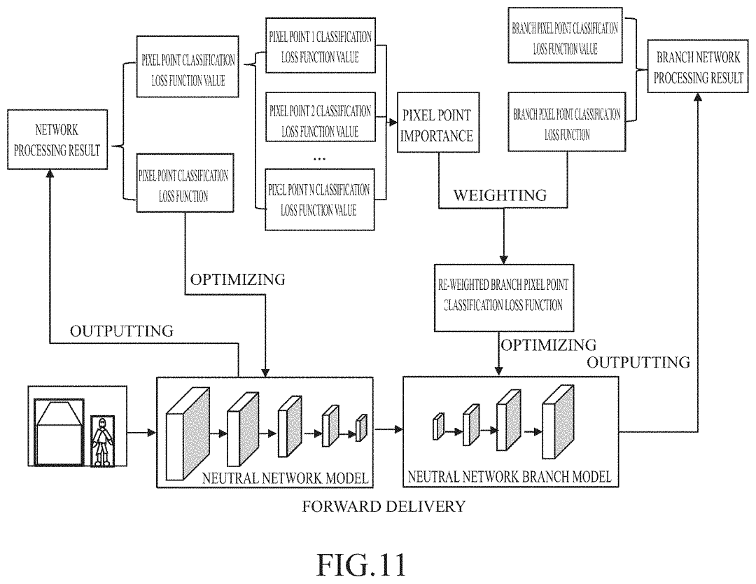

This embodiment is based on the neural network training method shown in FIG. 8C, and the method is used in semantic segmentation. The following will be described in detail with reference to FIG. 11.

First, a processing result of a first portion of a semantic segmentation neural network and a processing result of a branch network of a second portion are obtained. Then, in the pixel point classification task of the processing result, the importance of each pixel point (task) is evaluated. Semantic segmentation actually classifies each pixel point in an output image, so as to obtain regions occupied by different targets in the whole scene. Therefore, each pixel point can be used as a unit, and the method described above is used for importance evaluation, so that the network can pay attention to more important pixel point classification.

Then, the importance of the pixel point is taken as the attention weight of the pixel point loss function, and is assigned to the corresponding pixel point classification loss function in the additional branch processing result.

The neural network is then trained with the unweighted loss function in the processing result of the first portion of the neural network together with the re-weighted loss function in the branch result of the second portion of the neural network, and parameters are optimized. Specifically, the first portion of the neural network is optimized with the unweighted loss function, and the branch network in the neural network is optimized based on the re-weighted loss function. Similarly to the first exemplary embodiment, it is determined whether or not a training termination condition is satisfied, and in the case where the training termination condition is satisfied, the training process is ended, and a network model is output.

According to this exemplary embodiment, on the basis of the neural network training method of the first exemplary embodiment, training of the original distribution loss function is reserved, so that in the case where the neural network training method of this exemplary embodiment is applied to tasks such as target detection, target key point detection, semantic segmentation and the like, the neural network training method of this exemplary embodiment can also give consideration to training of common tasks while focusing on the training of difficult tasks, which contributes to further improvement of network performance.

### Third Exemplary Embodiment

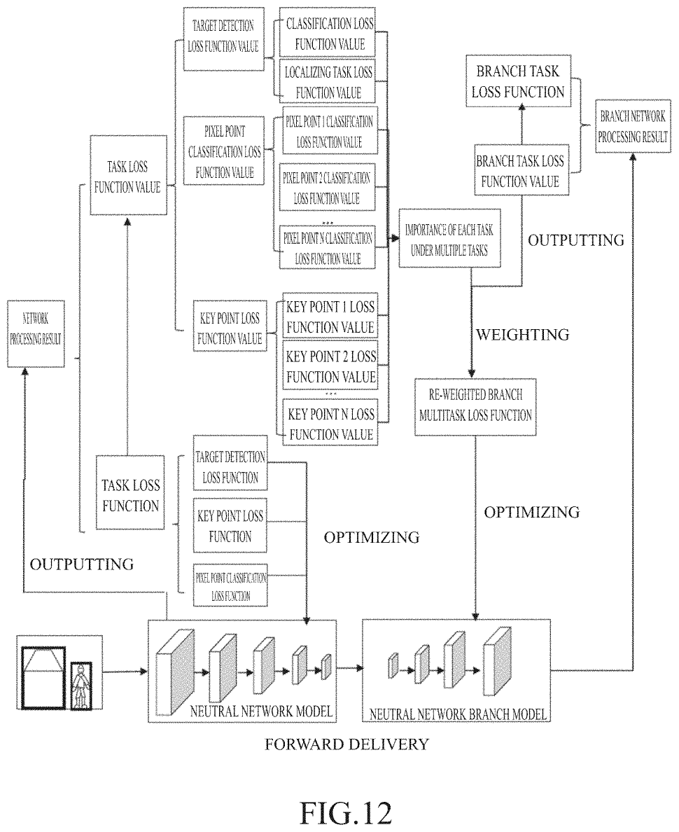

An exemplary embodiment in which the above method is applied to a neural network in a multitask integrated network and an additional branch network is added, for example, one network including tasks of target detection, target key point detection, and semantic segmentation and the like at the same time, will be described below with reference to FIG. 12. In this exemplary embodiment, portions different from the foregoing exemplary embodiments will be described with emphasis, and portions identical or similarly to the foregoing exemplary embodiments will be briefly described or omitted. The neural network optimization process shown in FIG. 12 differs from the neural network optimization process shown in FIG. 7A in that, in the neural network, a multitask neural network is used as a first portion, and on the basis of the first portion, an additional network branch is added as a second portion to assign an attention weight to a task loss function, instead of directly assigning an attention weight to a loss function in the original processing result of the first portion of the multitask neural network.

Specifically, first, a processing result of a multitask network and a processing result of its branch network are obtained. Next, similarly to the process of the first exemplary embodiment, in the processing result of a first portion of the neural network, the importance of each task under different tasks is evaluated. Specifically, for example, a classification task and a localizing task in target detection, a key point localizing task in target key point detection, and a pixel point classification task in semantic segmentation are used together as comparison targets to analyze the importance thereof.

Then, similarly to the second exemplary embodiment, the importance of the task under different tasks of the first portion of the neural network is used as an attention weight and assigned to the loss function of the corresponding task under different tasks in the branch processing result of the second portion of the neural network.

The network is then trained based on the obtained re-weighted task loss function along with the unweighted loss function and the network parameters are optimized. Specifically, the first portion of the neural network is optimized with the unweighted loss function, and the branch network as a second portion of the neural network is optimized based on the re-weighted loss function. Similarly to the first exemplary embodiment, it is determined whether or not a training termination condition is satisfied, and in the case where the training termination condition is satisfied, the training process is ended, and a network model is output.

### Fourth Exemplary Embodiment

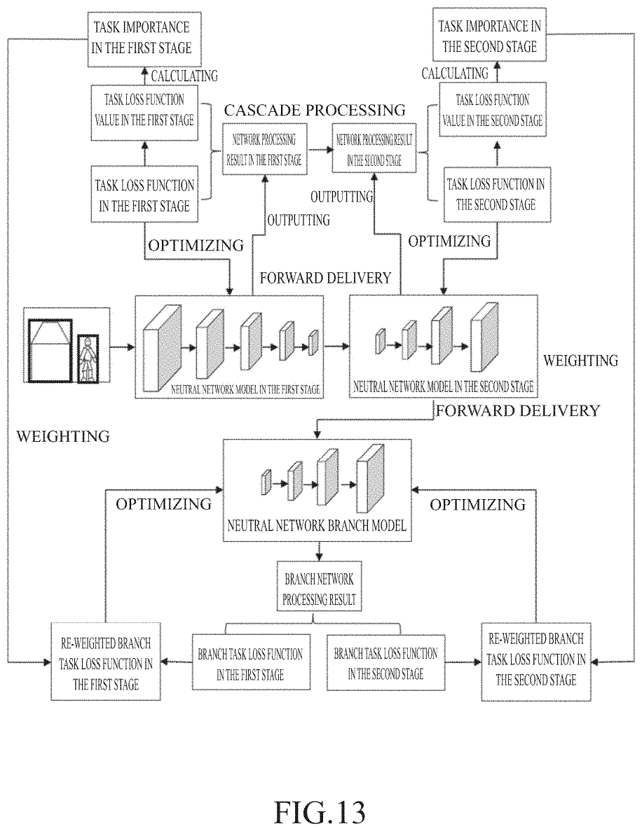

The fourth exemplary embodiment will be described below with reference to FIG. 13, in this exemplary embodiment, in a neural network, a multitask cascade network is used as a first portion, and an additional branch network is added as a second portion on the basis of the first portion. In this exemplary embodiment, portions different from the foregoing exemplary embodiments will be described with emphasis, and portions identical or similar to the foregoing exemplary embodiments will be briefly described or omitted. It should be noted that the branch processing result includes tasks corresponding to respective stages in the cascaded tasks and the processing results thereof (it seems that the results are the same).

Specifically, first, a processing result of each stage of a first portion of a neural network and a processing result of a branch network as a second portion of the neural network are obtained.

And then, cascade processing is carried out on the processing result of each stage of network of the first portion of the neural network to obtain the final output results of the respective stages. It should be noted that, in this embodiment, the processing results of the respective stages of the first portion of the neural network are correlated, and this step is to perform cascade processing on the processing results obtained by each stage of the first portion of the neural network to obtain the final processing results of the respective stages. At the same time, the processing result on the branch network of the neural network is also preserved for task weighting.

Then, similarly to the first exemplary embodiment, the importance of the task is evaluated based on the results after cascade processing of the respective stages of the first portion of the neural network.

Then, the importance of the tasks of respective stages of the first portion of the neural network is used as the attention weight of the task loss function, and is assigned to the corresponding task loss function in the processing result of the branch structure of the neural network.

The neural network is then trained with an unweighted loss function in a cascade network of the first portion of the neural network and a re-weighted loss function in the branch network of the neural network, and the parameters are optimized. Specifically, the cascade network of the first portion of the neural network is optimized with the unweighted loss function, and the branch network of the neural network is optimized based on the re-weighted loss function. Similarly to the first exemplary embodiment, it is determined whether or not a training termination condition is satisfied, and in the case where the training termination condition is satisfied, the training process is ended, and a network model is output.

### Modification Example 1

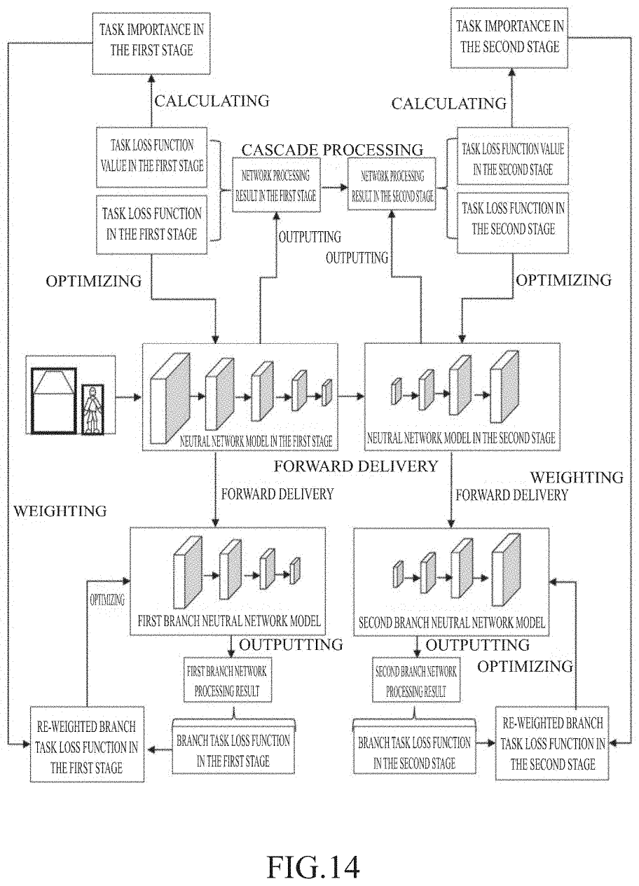

In the multitask cascade network, in addition to introducing an additional network branch as the second portion to be responsible for re-weighting tasks of all stages of the first portion of the neural network as in the embodiment described in FIG. 13, an additional branch may also be introduced for each stage of the first portion of the neural network to re-weight the task of that stage, respectively, as will be described below with reference to FIG. 14.

Specifically, first, a processing result of each stage of a first portion of a neural network and a processing result of its branch network are obtained. And then, cascade processing is carried out on the processing result of each stage of the first portion of the neural network to obtain the final output results of respective stages.

Then, the importance of the task is evaluated based on the results after cascade processing of the respective stages of the first portion of the neural network.

Then, the importance of the task is used as the attention weight of the task loss function, and is assigned to the corresponding task loss function in the corresponding branch processing result. Because the output of each stage in the network has an additional branch network to be responsible for re-weighting the task, based on the obtained task importance, the task importance is used as the attention weight of the task and is assigned to the corresponding task loss function in the processing result of the corresponding branch.

The neural network is then trained with an unweighted loss function in the cascade network and a re-weighted loss function on the additional branch, and the parameters are optimized. Specifically, the cascade network of the first portion of the neural network is optimized with the unweighted loss function, and the branch network of the neural network is optimized based on the re-weighted loss function. Similarly to the first exemplary embodiment, it is determined whether or not a training termination condition is satisfied, and in the case where the training termination condition is satisfied, the training process is ended, and a network model is output.

In this embodiment, tasks of different stages in the first portion of the neural network are processed and re-weighted with different branch networks in the second portion of the neural network, in this way, the performance can further be improved since parameters are not shared among branch networks and each branch network in the neural network is dedicated to processing in a certain stage.

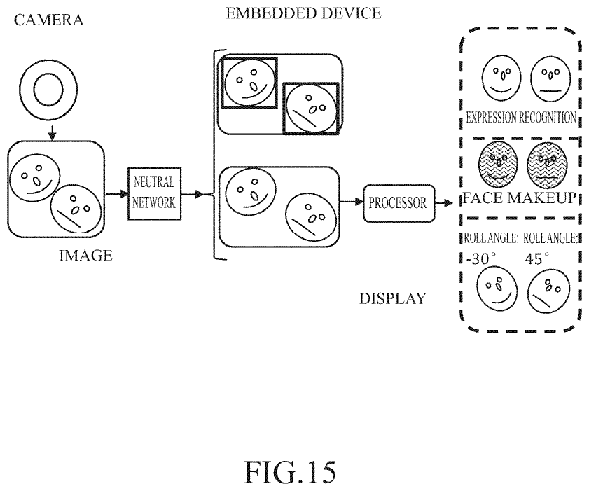

FIG. 15 shows an example of an application of a training method of a neural network according to the present disclosure, assuming that a camera, a neural network, a processor, and a display are included in the training device. The camera is used for obtaining images, the images are fed into the network for processing, and a multitask network carries out forward inference on the images by using the training method of the present disclosure to generate an inference result. The result containing multitask information is then fed into the processor, which then processes the multitask information to produce a desired result, such as emotion recognition, face makeup, face pose estimation, etc. The produced result is fed into the display which will present the processed images on a display screen so that the user can view the visualized result.

All the units described above are exemplary and/or preferred modules for implementing the processes described in the present disclosure. These units may be hardware units (such as field programmable gate arrays (FPGAs), digital signal processors, application specific integrated circuits, etc.) and/or software modules (such as computer readable programs). The units for carrying out the steps have not been described in detail above. However, in the case where there is a step of performing a specific process, there may be a corresponding functional module or unit (implemented by hardware and/or software) for implementing the same process. The technical solutions through all combinations of the described steps and the units corresponding to the steps are included in the disclosure of the present application, as long as the technical solutions formed by them are complete and applicable.

The methods and devices of the present disclosure can be implemented in a number of ways. For example, the methods and devices of the present disclosure may be implemented in software, hardware, firmware, or any combination thereof. Unless specifically stated otherwise, the above-described order of the steps of the method is intended to be illustrative only, and the steps of the method of the present disclosure are not limited to the order specifically described above. Furthermore, in some embodiments, the present disclosure may also be embodied as a program recorded in a recording medium, which includes machine-readable instructions for implementing the method according to the present disclosure. Therefore, the present disclosure also covers a recording medium storing a program for implementing the method according to the present disclosure.

While the present disclosure has been described with reference to exemplary embodiments, the scope of the following claims are to be accorded the broadest interpretation so as to encompass all such modifications and equivalent structures and functions.

This application claims the benefit of Chinese Patent Application No. 202110325842.4, filed Mar. 26, 2021, which is hereby incorporated by reference herein in its entirety.

What is claimed is:

1. A method of training a neural network, comprising:
obtaining, for at least one task, a processing result and loss function value thereof after performing processing in a neural network on a sample image; wherein the neural network includes at least one network structure;
determining importance of the processing result based on the obtained loss function value;
adjusting a weight of the loss function used to obtain the loss function value, based on the determined importance; and
updating the neural network based on the loss function the weight of which is adjusted.

2. The method according to claim 1, wherein, in the determining, regarding different tasks within same object in the sample image, determining importance of the processing result of each task is determined.

3. The method according to claim 1, wherein, in the determining, regarding same tasks across different objects in the sample image, determining importance of the processing result of each task is determined.

4. The method according to claim 1, wherein, in the determining, the greater the loss function value of the processing result is, the higher the importance of the processing result is.

5. The method according to claim 1, wherein, in the determining, the greater the loss function value of the processing result is, the lower the importance of the processing result is.

6. The method according to claim 1, wherein, in the determining, the processing results are sorted according to the loss function values, and the importance of the processing result is determined based on a sorted order thereof.

7. The method according to claim 1, wherein, in the determining, in a case where the loss function is a regression loss function or an intersection-over-union loss function, the importance of the processing result is determined based on a likelihood value of the loss function value;
wherein, the greater the likelihood value is, the lower the importance of the processing result is.

8. The method according to claim 1, wherein, in the determining, in a case where the loss function is a regression loss function or an intersection-over-union loss function, the importance of the processing result is determined based on a likelihood value of the loss function value;
wherein, the greater the likelihood value is, the higher the importance of the processing result is.

9. The method according to claim 1, wherein, the at least one network structure in the neural network can process one or more tasks.

10. The method according to claim 9, wherein, in a case where the neural network is a network where tasks are cascaded, the processing result of a latter task is adjusted and obtained based on the processing result of a previous task.

11. A method of training a neural network, the neural network including at least a first portion and a second portion for receiving output from the first portion, the first portion including at least one sub network structure, the method comprising:
obtaining, for at least one task, a first processing result and a first loss function value thereof after performing processing in the first portion of the neural network on a sample image;
updating the first portion of the neural network based on the first loss function;
obtaining, for the at least one task, a second loss function of a second processing result after performing processing in the second portion of the neural network on a sample image;
determining first importance of the first processing result, based on the first loss function value;
adjusting a weight of the second loss function, based on the first importance; and
updating the second portion of the neural network based on the second loss function the weight of which is adjusted.

12. The method according to claim 11, wherein, for any sub network structure in the first portion, the output thereof is received by one branch network structure in the second portion.

13. A method for training a neural network for object detection, comprising:
obtaining a processing result and loss function value thereof after performing processing of neural network on a sample image, wherein, the neural network includes at least one network structure, wherein the processing result includes a classification processing result and a localizing processing result; wherein, the loss function of the classification processing result is a probability loss function, and the loss function of the localizing processing result is a regression loss function or an intersection-over-union loss function;
determining the importance of the processing result based on the obtained loss function value;
adjusting a weight of the loss function used to obtain the loss function value, based on the determined importance; and
updating the neural network based on the loss function the weight of which is adjusted.

14. A method for training a neural network for object detection, the neural network including at least a first portion and a second portion for receiving output from the first portion, the first portion including at least one sub network structure, the method comprising:
obtaining, for at least one task, a first processing result and a first loss function value thereof after performing processing in the first portion of the neural network on a sample image, wherein the first processing result includes a classification processing result and a localizing processing result, wherein, the loss function of the classification processing result is a probability loss function, and the loss function of the localizing processing result is a regression loss function or an intersection-over-union loss function;
updating the first portion of the neural network based on the first loss function;
obtaining a second processing result and a second loss function value thereof after performing processing in the second portion of the neural network on a sample image;
determining first importance of the first processing result, based on the first loss function value;
adjusting a weight of the second loss function, based on the first importance; and
updating the second portion of the neural network based on the second loss function the weight of which is adjusted.

15. The method according to claim 14, wherein, the first portion of the neural network comprises two network structures, the one is used for the first classification processing and the first localization processing, the other is used for the second classification processing and the second localization processing.

16. The method according to claim 15, wherein, the processing result of the second classification processing and the second localization processing is adjusted and obtained based on the processing result of the first classification processing and the first localization processing.

17. The method according to claim 16, wherein, for any one of the sub network structure used for the first classification processing and the first localization processing and the sub network structure used for the second classification processing and the second localization processing in the first portion, the output thereof is received by one branch network structure in the second portion of the neural network.

18. A method for training a neural network for face landmark detection, comprising:
obtaining a landmark detection result and landmark loss function value thereof after performing processing in the neural network on a sample image;
determining the importance of the landmark detection result based on the obtained landmark loss function value;
adjusting the weight of the landmark loss function based on the determined importance; and
updating the neural network based on the landmark loss function the weight of which is adjusted.

19. A method for training a neural network for face landmark detection, the neural network including as least a first portion and a second portion for receiving output from the first portion:
obtaining a first landmark detection result and a first landmark loss function value thereof after performing processing in the first portion of the neural network on a sample image;
updating the first portion of the neural network based on the first landmark loss function;
obtaining a second landmark detection result and a second landmark loss function thereof after performing processing in the second portion of the neural network on a sample image;
determining first importance of the first landmark detection result, based on the first landmark loss function value;
adjusting the weight of the second loss landmark function, based on the first importance; and
updating the second portion of the neural network based on the second loss landmark function the weight of which is adjusted.

20. An application method of a neural network comprising:
storing the neural network which is trained based on a training method;
receiving a data set corresponding to tasks required by the neural network;
processing the data set in each layer from top to bottom in the neural network, and outputting a processing result,
wherein the training method, comprising:
obtaining, for at least one task, a processing result and loss function value thereof after performing processing in the neural network on a sample image; wherein the neural network includes at least one network structure;
determining importance of the processing result based on the obtained loss function value;
adjusting a weight of the loss function used to obtain the loss function value, based on the determined importance; and
updating the neural network based on the loss function the weight of which is adjusted.

21. A device of training a neural network, comprising:
an obtaining unit configured to, for at least one task, obtain a processing result and loss function value thereof after performing processing in a neural network on a sample image; wherein the neural network includes at least one network structure;
a determining unit configured to, determine importance of the processing result, based on the obtained loss function value;
an adjustment unit configured to, adjust a weight of the loss function used to obtain the loss function value, based on the determined importance; and
an updating unit configured to, update the neural network based on the loss function the weight of which is adjusted.

22. A device of training a neural network, the neural network including at least a first portion and a second portion for receiving output from the first portion, the first portion including at least one sub network structure, the device comprising:
a first obtaining unit configured to, for at least one task, obtain a first processing result and a first loss function value thereof after performing processing in the first portion of the neural network on a sample image;
a first updating unit configured to, update the first portion of the neural network based on the first loss function;
a second obtaining unit configured to, for the at least one task, obtain a second loss function of a second processing result after performing processing in the second portion of the neural network on a sample image;
a determining unit configured to, determine first importance of the first processing result, based on the first loss function value;
an adjustment unit configured to, adjust a weight of the second loss function, based on the first importance; and
a second updating unit configured to, update the second portion of the neural network based on the second loss function the weight of which is adjusted.

23. A neural network application device comprising:
a storage module configured to store a neural network trained based on a training method;
a receiving module configured to receive a data set corresponding to requirements of a task that the neural network can perform;
a processing module configured to process the data set in each layer from top to bottom in the neural network, and output a result of the process,
wherein the training method, comprising:
obtaining, for at least one task, a processing result and loss function value thereof after performing processing in the neural network on a sample image; wherein the neural network includes at least one network structure;
determining importance of the processing result based on the obtained loss function value;
adjusting a weight of the loss function used to obtain the loss function value, based on the determined importance; and
updating the neural network based on the loss function the weight of which is adjusted.

24. A non-transitory computer readable storage medium storing instructions for causing a computer to perform a method of training a neural network, the method comprising:
obtaining, for at least one task, a processing result and loss function value thereof after performing processing in a neural network on a sample image; wherein the neural network includes at least one network structure;
determining importance of the processing result based on the obtained loss function value;
adjusting a weight of the loss function used to obtain the loss function value, based on the determined importance; and
updating the neural network based on the loss function the weight of which is adjusted.
